(19) United States
(12) Patent Application Publication
(10) Pub. No.: US 2010/0084394 A1
(43) Pub. Date: Apr. 8, 2010

(54) HEAT GENERATING UNIT AND HEATING APPARATUS

(75) Inventors: Masanori Konishi, Kagawa (JP); Tsugunori Okahara, Kagawa (JP); Hiroaki Matsuoka, Kagawa (JP); Akira Nishio, Kagawa (JP)

Correspondence Address: HAMRE, SCHUMANN, MUELLER & LARSON P.C., P.O. BOX 2902-0902, MINNEAPOLIS, MN, 55402, US

(73) Assignee: Panasonic Corporation, Osaka (JP)

(21) Appl. No.: 12/525,205

(22) PCT Filed: Jan. 24, 2008
(86) PCT No.: PCT/JP2008/050960

§ 371 Date: Jul. 30, 2009

(30) Foreign Application Priority Data
Feb. 2, 2007 (JP) 2007-023851
Dec. 17, 2007 (JP) 2007-324418

(51) Int. Cl. H05B 3/44; H05B 3/06; H05B 3/10

(52) U.S. Cl. 219/534; 219/544; 219/553

(57) ABSTRACT

An objective of the present invention is to provide a heat generating unit that has a small size with high efficiency and high directivity, and carries out a uniform heating process with a fast temperature rise, and a heating apparatus using such a heat generating unit. The heat generating element (2) in the heat generating unit is formed into a film-sheet shape by using a material mainly composed of a carbon-based substance, and has an equivalent thermal conductivity in a plane direction, and power supply parts (10A, 10B) supply power to two opposing ends of the heat generating element (2) so that the entire heat generating element (2) in the heat generating unit generates heat with high efficiency.

### TECHNICAL FIELD

The present invention relates to a heat generating unit used for a heat source and a heating apparatus using such a heat generating unit, and in particular, relates to a heat generating unit having a heat generating element that is mainly composed of a carbon-based substance and formed into a film-sheet shape and a heating apparatus using such a heat generating unit.

### BACKGROUND ART

A conventional heat generating unit having an elongated shape to be used as a heat source has a structure in which a coil shaped tungsten wire or a rod-shaped or plate-shaped carbon-based sintered body is sealed in a cylinder-shaped glass tube as a heat generating element. Examples of heating apparatuses using such a heat generating unit include: various apparatuses that require heat sources, such as electronic apparatuses including copying machines, facsimiles and printers, and electric appliances including electric heating apparatuses, cooking apparatuses and drying apparatuses.

Heat generating units have been widely used in the various apparatuses as heat sources. For this reason, there have been various demands for a heat generating unit so as to meet specifications of the function, shape, structure and the like of an apparatus to which the heat generating unit is applied. For example, those demands include to provide a high temperature as a heat source, to maintain a specified temperature, to have a wide temperature adjusting range, to allow an input power to be converted to heating energy with high efficiency, to uniformly heat an object to be heated, to have directivity so that heating is applied only in a specified direction, to have little rush current upon application of power, to have a quick temperature rise up to a predetermined temperature, and to have a structure capable of miniaturizing the heat generating unit, which is easily detachably attached.

In order to satisfy the above-mentioned demands, various heat generating units have been proposed. For example, as a conventional heat generating unit that carries out a heating process to a high temperature, a structure has been proposed in which a tape-shaped heat generating element, formed by allowing carbon fibers to be impregnated with a resin to be secured, is sealed in a glass tube (for example, see JP-A No. 2004-193130). Patent Document 1: JP-A No. 2004-193130

### DISCLOSURE OF THE INVENTION

### Problems to be Solved by the Invention

In the conventional heat generating unit having a structure as described above, carbon fibers are aligned in the longitudinal direction and joined to be fixed into a tape shape with a resin so that a heat generating element is formed. In the conventional heat generating element formed in this manner, since the carbon fibers are kept in a connected state, it exerts superior thermal conductivity in a direction in parallel with the carbon fibers (direction of carbon fibers); however, when subjected to a machining process so as to adjust resistance or the like, the thermal conductivity in the direction of carbon fibers deteriorates abruptly since the carbon fibers are cut partially. Moreover, since the thermal conductivity in a direction orthogonal to the direction of carbon fibers is low, temperature variations tend to occur in the respective heat generating units serving as heat sources, resulting in a problem with reliability. Moreover, cracks tend to develop from the cut portions of the carbon fibers forming the starting points, resulting in a problem of short service life.

Moreover, since the heat generating element of the conventional heat generating unit has a structure formed by joining carbon fibers to be fixed by a resin, it has no pliability with the result that it is difficult to satisfy various specifications required for a heat source used in a heating apparatus.

The present invention has been devised to solve the above-mentioned problems with the conventional heat generating element, and its objective is to provide a heat generating unit that has a small size with high efficiency and high directivity, and carries out a uniform heating process with a fast temperature rise, and a heating apparatus using such a heat generating unit.

### Means for Solving the Problems

In order to solve the above-mentioned problems and achieve the object of the present invention, a heat generating unit according to a first aspect of the present invention includes: a heat generating element that is formed into a film shape by using a material containing a carbon-based substance, and has an equivalent thermal conductivity in a plane direction; a power supply part that supplies power to two opposing ends of the heat generating element; and a container that encloses the heat generating element and the power supply part. In the heat generating unit configured as described above, since the heat generating element, mainly composed of a carbon-based material and formed into a film-sheet shape, has substantially the same thermal conductivity in a plane direction, that is, a so-called two dimensional isotropic thermal conductivity, the entire surface is allowed to generate heat upon application of power so that a heat source having a fast temperature rise is achieved.

In a heat generating unit according to a second aspect of the present invention, the heat generating element includes an applied-power heat-generating portion in which a current flows to generate heat and radiate heat, and a conducted heat-generating portion in which heat is generated to radiate the heat due to thermal conduction from the applied-power heat-generating portion. In the heat generating unit configured as described above, since the heat generating element has substantially the same thermal conductivity in a plane direction, that is, a so-called two dimensional isotropic thermal conductivity, not only the power-applied heat-generating portion, but also the conducted heat-generating portion is allowed to generate heat with high efficiency.

In a heat generating unit according to a third aspect of the present invention, the heat generating element has a structure in which wide width portions and narrow width portions are sequentially and alternately disposed in a longitudinal direction. In the heat generating unit configured as described above, since the heat generating element has substantially the same thermal conductivity in a plane direction, that is, a so-called two dimensional isotropic thermal conductivity, the wide width portions and the narrow width portions are respectively allowed to generate heat with high efficiency.

In a heat generating unit according to a fourth aspect of the present invention, a hole is formed in each of the wide width portions of the heat generating element to prepare a power-applied heat-generating passage so that the heat generating element has a wide width portion which has a different resistance value per unit length in the power-applied heat-generating passage. In the heat generating unit configured as described above, it becomes possible to easily and reliably set a desired temperature distribution.

In a heat generating unit according to a fifth aspect of the present invention, the power supply part has a holding block that holds the heat generating element, with a heat resistant member being formed on at least one side of the holding portion in the heat generating element. In the heat generating unit configured as described above, the heat generating element is reliably held by the power supply part so that it is possible to achieve a heat source with high reliability.

In a heat generating unit according to a sixth aspect of the present invention, the power supply part has a holding block that holds the heat generating element, with a convex portion being formed on one portion of the holding portion of the holding block. In the heat generating unit configured as described above, the heat generating element is reliably held by the power supply part so that it is possible to achieve a heat source with high reliability.

In a heat generating unit according to a seventh aspect of the present invention, the heat generating element is formed by using a material having pliability, flexibility and elasticity. In the heat generating unit configured as described above, a machining process of the heat generating element, an assembling process into an apparatus, and a designing process of the apparatus can be easily carried out.

In a heat generating unit according to an eighth aspect of the present invention, at least one portion of areas in the longitudinal direction in the heat generating element is configured so as to have a different resistance value per unit length in the longitudinal direction. In the heat generating unit configured as described above, it becomes possible to easily and reliably set a desired temperature distribution.

In a heat generating unit according to a ninth aspect of the present invention, the container is configured by using either a glass tube or a ceramic tube having a heat resistant property. In the heat generating unit configured as described above, it becomes possible to structurally protect the heat generating element with the heat resistant container.

In a heat generating unit according to a tenth aspect of the present invention, at least one portion of a cross-sectional shape orthogonal to the longitudinal direction of the heat generating element is formed into a curved face. In the heat generating unit configured as described above, the heat generating element can be easily designed in accordance with service objectives.

In a heat generating unit according to an eleventh aspect of the present invention, at least one portion of the container in the longitudinal direction is formed into a curved face. In the heat generating unit configured as described above, a degree of freedom in designing can be expanded in accordance with service objectives.

In a heat generating unit according to a twelfth aspect of the present invention, at least one of the ends of the tube-shaped container is sealed at the power supply part, with the container being filled with an inert gas. In the heat generating unit configured as described above, it becomes possible to prevent the heat generating element from being oxidized and consequently to provide a longer service life.

In a heat generating unit according to a thirteenth aspect of the present invention, the heat generating element has a film sheet shape in which a plurality of film sheet materials are laminated in a thickness direction with one another, with a void being formed therebetween, by using a material having a conductivity of 200 W/m·K or more. In the heat generating unit configured as described above, since the heat generating element, mainly composed of a carbon-based material and formed into a film-sheet shape, has a structure in which a plurality of film sheet materials are laminated in a thickness direction, and consequently exerts the same thermal conductivity in respective plane directions, that is, a so-called two dimensional isotropic thermal conductivity, the entire surface is allowed to generate heat upon application of power so that a heat source having a fast temperature rise is achieved.

In a heat generating unit according to a fourteenth aspect of the present invention, the heat generating element is formed into a film sheet shape with a thickness of 300 μm or less. In the heat generating unit configured as described above, it becomes possible to easily design the heat generating element in accordance with service objectives, and also to achieve a heat source with high directivity.

In a heat generating unit according to a fifteenth aspect of the present invention, the heat generating element is formed by using a graphite film obtained by subjecting a polymer film, or a polymer film to which a filler is added, to a heating treatment at a temperature of 2400° C. or more. In the heat generating unit configured as described above, since the heat generating element has substantially the same thermal conductivity in a plane direction, that is, a so-called two dimensional isotropic thermal conductivity, a heat generating process is carried out with high efficiency.

In a heat generating unit according to a sixteenth aspect of the present invention, at least one portion of an outer shape, a hole shape and a cut-in shape of the heat generating element is formed by a laser machining process. The heat generating unit formed as described above, is allowed to have a desired shape with superior machining precision, and a stable resistance value can be obtained.

A heating apparatus according to a seventeenth aspect of the present invention includes: a heat generating unit that includes: a heat generating element that is formed into a film shape by using a material containing a carbon-based substance, and has an equivalent thermal conductivity in a plane direction; a power supply part that supplies power to two opposing ends of the heat generating element; and a container that encloses the heat generating element and the power supply part, wherein reflective means is disposed at a position opposite to the heat generating element. In the heating apparatus configured as described above, since the heat generating unit and the reflective means for reflecting radiated heat from the heat generating unit are installed, the heating apparatus is provided with a heat source with high efficiency.

In a heating apparatus according to an eighteenth aspect of the present invention, the heat generating element includes an applied-power heat-generating portion in which a current flows to generate heat and radiate heat, and a conducted heat-generating portion in which heat is generated to radiate the heat due to thermal conduction from the applied-power heat-generating portion. In the heating apparatus configured as described above, since the heat generating element has substantially the same thermal conductivity in a plane direction, that is, a so-called two dimensional isotropic thermal conductivity, not only the power-applied heat-generating portion, but also conducted heat-generating portion is allowed to generate heat so that the heating apparatus is provided with a heat source with high efficiency.

In a heating apparatus according to a nineteenth aspect of the present invention, the heat generating element has a structure in which wide width portions and narrow width portions are sequentially and alternately disposed in a longitudinal direction. In the heating apparatus configured as described above, since the heat generating element has substantially the same thermal conductivity in a plane direction, that is, a so-called two dimensional isotropic thermal conductivity, the wide width portions and the narrow width portions are respectively allowed to generate heat so that the heating apparatus is provided with a heat source with high efficiency.

In a heating apparatus according to a twentieth aspect of the present invention, a hole is formed in each of the wide width portions of the heat generating element to prepare a power-applied heat-generating passage so that the heat generating element has a wide width portion which has a different resistance value per unit length in the power-applied heat-generating passage. In the heating apparatus configured as described above, it becomes possible to easily and reliably set a desired temperature distribution.

In a heating apparatus according to a twenty-first aspect of the present invention, the reflective means is a reflective plate having a cross-sectional face in a longitudinal direction, formed into a curved shape. In the heating apparatus configured as described above, it becomes possible to heat an object to be heated, by radiated heat from the heat generating element with high efficiency.

In a heating apparatus according to a twenty-second aspect of the present invention, the reflective means is a reflective plate having a cross-sectional face in a longitudinal direction, with a convex portion protruding toward the heat generating element being formed at one portion of the reflective plate. In the heating apparatus configured as described above, since the reflective plate prevents the heat generating element from being heated, it is possible to realize a heating state as specified at the time of designing.

In a heating apparatus according to a twenty-third aspect of the present invention, the reflective means is a reflective film formed on the heat generating unit. In the heating apparatus configured as described above, it becomes possible to heat an object to be heated, by radiated heat from the heat generating element with high efficiency.

A heating apparatus according to a twenty-fourth aspect of the present invention includes: a heat generating unit that includes: a heat generating element that is formed into a film shape by using a material containing a carbon-based substance, and has an equivalent thermal conductivity in a plane direction; a power supply part that supplies power to two opposing ends of the heat generating element; and a container that encloses the heat generating element and the power supply part, wherein a tube member is disposed so as to surround a periphery of the heat generating unit. The heating apparatus, configured in this manner, can be applied to an electronic apparatus having a toner fixing mechanism, a cooking appliances and the like.

In a heating apparatus according to a twenty-fifth aspect of the present invention, the heat generating element includes an applied-power heat-generating portion in which a current flows to generate heat and radiate heat, and a conducted heat-generating portion in which heat is generated to radiate the heat due to thermal conduction from the applied-power heat-generating portion. In the heating apparatus configured as described above, since the heat generating element has substantially the same thermal conductivity in a plane direction, that is, a so-called two dimensional isotropic thermal conductivity, not only the power-applied heat-generating portion, but also conducted heat-generating portion is allowed to generate heat so that the heating apparatus is provided with a heat source with high efficiency.

In a heating apparatus according to a twenty-sixth aspect of the present invention, the heat generating element has a structure in which wide width portions and narrow width portions are sequentially and alternately disposed in a longitudinal direction. In the heating apparatus configured as described above, since the heat generating element has substantially the same thermal conductivity in a plane direction, that is, a so-called two dimensional isotropic thermal conductivity, the wide width portions and the narrow, width portions are respectively allowed to generate heat so that the heating apparatus is provided with a heat source with high efficiency.

In a heating apparatus according to a twenty-seventh aspect of the present invention, a hole is formed in each of the wide width portions of the heat generating element to prepare a power-applied heat-generating passage so that the heat generating element has a wide width portion which has a different resistance value per unit length in the power-applied heat-generating passage. In the heating apparatus configured as described above, it becomes possible to easily and reliably set a desired temperature distribution.

A heating apparatus according to a twenty-eighth aspect of the present invention, further includes: a control circuit that carries out an electrical controlling process on the heat generating unit, wherein the control circuit is provided with one of circuits or at least two or more of combined circuits, selected from an ON/OFF control circuit, a duty factor control circuit, a phase control circuit and a zero-cross control circuit. The heating apparatus configured as described above makes it possible to form a heat source having a desired temperature distribution with high precision.

### EFFECTS OF THE INVENTION

In accordance with the present invention, it is possible to provide a heat generating unit that has a small size with high efficiency and high directivity, and carries out a uniform heating with a fast temperature rise, and a heating apparatus using such a heat generating unit.

### BRIEF DESCRIPTION OF THE DRAWINGS

FIG. 1 is a plan view showing a structure of a heat generating unit in accordance with embodiment 1 of the present invention;

FIG. 2 is a partial plan view showing a structure of the heat generating element in accordance with embodiment 1 of the present invention;

FIG. 3 is a partial cross-sectional view showing a structure of a holding block in accordance with embodiment 1 of the present invention;

FIG. 4 is partial cross-sectional views that show various structural examples of other heat generating elements in accordance with embodiment 1 of the present invention;

FIG. 5 is partial plan views that show various structural examples of heat generating elements in accordance with embodiment 2 of the present invention;

FIG. 6 is partial plan views that show various structural examples of heat generating elements in accordance with embodiment 3 of the present invention;

FIG. 7 is a perspective view showing a structure of a heat generating unit in accordance with embodiment 4 of the present invention;

FIG. 8 is a perspective view showing a structure of a heat generating element in accordance with embodiment 4 of the present invention;

FIG. 9 is perspective views that show various structural examples of other heat generating elements in accordance with embodiment 4 of the present invention;

FIG. 10 is cross-sectional views showing structures of a heat radiating source in a heating apparatus in accordance with embodiment 5 of the present invention;

FIG. 11 is a cross-sectional view showing structures of a heat radiating source and the like in accordance with embodiment 6 of the present invention; and

FIG. 12 is a view showing a schematic structure of a temperature controlling device in the heating apparatus in accordance with embodiment 6 of the present invention.

### BEST MODE FOR CARRYING OUT THE INVENTION

Hereinafter, embodiments of a heat generating unit and a heating apparatus using such a heat generating unit in accordance with the present invention will be described with reference to attached drawings.

### Embodiment 1

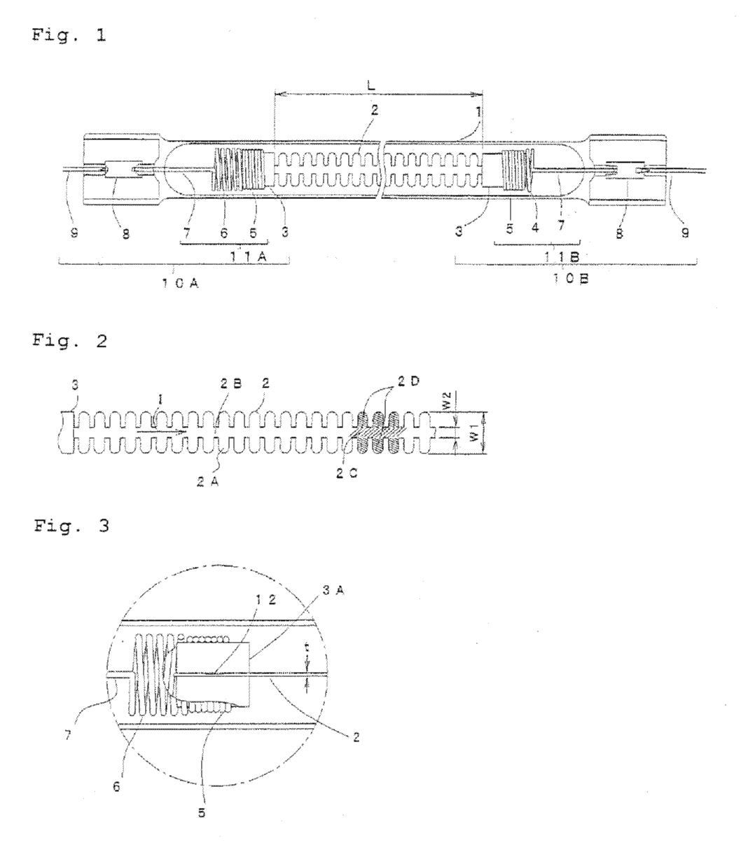

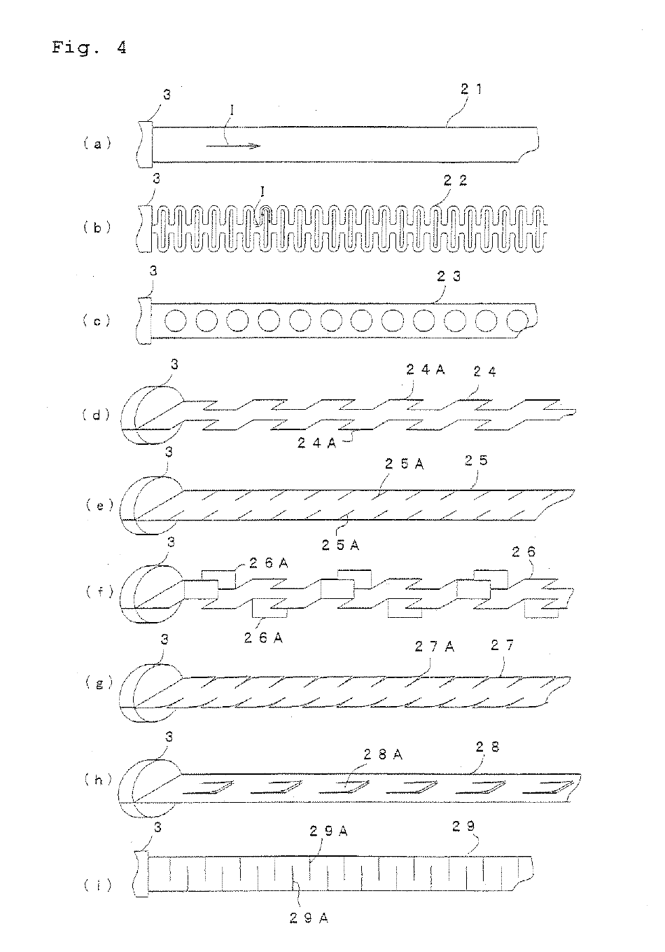

Referring to FIGS. 1 to 3, a heat generating unit in accordance with embodiment 1 of the present invention will be described. FIG. 1 is a plan view showing a structure of the heat generating unit in accordance with embodiment 1. In FIG. 1, since the heat generating unit has an elongated shape, a middle portion thereof is exploded and omitted, and portions near two ends thereof are shown. FIG. 2 is a front view showing one portion of the heat generating element in the heat generating unit of embodiment 1. FIG. 3 is an enlarged view showing one portion of the heat generating unit of embodiment 1 in an enlarged manner.

In the heat generating unit of embodiment 1, an elongated heat generating element 2 is placed inside a glass tube 1 made of transparent quartz glass, and the heat generating element 2 is extended in a longitudinal direction along the glass tube 1. Moreover, the two ends of the glass tube 1 are fused and adhered to be formed into flat plates, and the heat generating element 2 is sealed inside the glass tube 1 together with an inert gas, such as an argon gas, a nitrogen gas, or a mixed gas of an argon gas and a nitrogen gas. The argon gas, nitrogen gas or the mixed gas of the argon gas and nitrogen gas, that is, the inert gas sealed inside the glass tube 1, is used so as to prevent oxidation of the heat generating element 2 made of a carbon-based substance, when used under high temperatures.

As shown in FIG. 1, the heat generating unit of embodiment 1 is provided with a heat generating element 2 having an elongated flat plate shape, which serves as a heat radiator, and holding blocks 3 that are placed on the opposing two ends of the heat generating element 2 so as to sandwich and hold the heat generating element 2. A first internal lead wire member 11A is attached to one of the holding blocks 3 (holding block 3 on the left side in FIG. 1), and a second internal lead wire member 11B is attached to the other holding block 3 (holding block 3 on the right side in FIG. 1). Each of the first internal lead wire member 11A and second internal lead wire member 11B is electrically connected to an external lead wire 9 that is drawn out of each of the two ends of the glass tube 1 through a molybdenum foil 8 embedded into each of fused portions of the two ends of the glass tube 1.

The first internal lead wire member 11A is configured by a coil portion 5 that is wound around the outer circumferential face of the holding block 3 (holding block 3 on the left side in FIG. 1) to be adhered thereto, a spring portion 6 having elasticity, formed into a spiral shape, and an internal lead wire 7 that is connected to the molybdenum foil 8, which are formed into a single wire member. Moreover, the second internal lead wire member 11B is configured by a coil portion 5 that is wound around the outer circumferential face of the holding block 3 (holding block 3 on the right side in FIG. 1) to be adhered thereto, a holding portion 4 connected to the coil portion 5 and an internal lead wire 7 that is connected to the molybdenum foil 8, which are formed into a single wire member. In embodiment 1, the first internal lead wire member 11A and the second internal lead wire member 11B are exemplified by a structure made of a molybdenum wire; however, these members may be made of a metal wire (round-rod shape or flat-plate shape) having elasticity, made of tungsten, nickel, stainless or the like.

In embodiment 1, a first power supply part 10A is configured by the holding block 3, the molybdenum foil 8, the external lead wire 9 and the first internal lead wire member 11A, and a second power supply part 10B is configured by the holding block 3, the molybdenum foil 8, the external lead wire 9 and the second internal lead wire member 11B.

Note that the spring portion 6 of the first internal lead wire member 11A is used for applying a tension to the heat generating element 2, and designed so that the heat generating element 2 is always placed at a desired position. In other words, the heat generating element 2 is disposed substantially on the center axis of the glass tube 1 so as not to come in contact with the glass tube 1. Moreover, by forming the spring portion 6 between the internal lead wire 7 and the coil portion 5, it becomes possible to absorb a change in the heat generating element 2 due to expansion and contraction.

In the case where the elongation percentage of the material of the heat generating element 2 or the elongation percentage derived from the shape of the heat generating element 2 is large relative to the change due to the expansion and contraction of the heat generating element 2, it is not necessary to install the spring portions 6 on the respective internal lead wire members on the two ends of the heat generating element 2.

In the heat generating unit of embodiment 1, the coil portion 5 is wound around the outer circumferential face of each holding block 3 to be adhered thereto; however, no coil portion is wound around on substantially half of the outer circumferential face of the holding block 3 to be kept in an exposed state. Therefore, heat transmitted from the heat generating element 2 is emitted from the holding block 3.

The heat generating unit of embodiment 1 is exemplified by a structure with the internal lead wire members 11A and 11B having different structures that are placed on the two ends of the heat generating element 2; however, the heat generating unit of the present invention may have structural members having the same structure as the first internal lead wire member 11A, attached to the two ends of the heat generating element 2, and these structures may be altered on demand in accordance with the specification or the like of the heating apparatus in which the heat generating unit is used. By placing the first internal lead wire member 11A having the spring portion 6 on either one of the ends of the heat generating element 2, the positional regulation and the change absorption of the heat generating element 2 can be obtained; however, a further effect can be expected when the first internal lead wire members 11A are installed on the two ends of the heat generating element 2.

Note that in the heating apparatus, in the case where the heat generating unit is assembled with its longitudinal direction being aligned to the vertical direction, if the spring portion 6 is placed above the heat generating element 2, the spring portion 6 heated by the temperature of the heat generating element 2 exceeds its elastic limitation and a failure to absorb the heat expansion may be caused; therefore, the spring portion 6 is preferably disposed below the heat generating element 2.

Moreover, the heat generating unit in embodiment 1 is exemplified by a structure in which the coil portion 5 of the first internal lead wire member 11A, the spring portion 6 and the internal lead wire 7, as well as the coil portion 5 of the second internal lead wire member 11B, the holding portion 4 and the internal lead wire 7, are integrally formed; however, needless to say, even when the respective members are formed with different members, the same effects can be obtained as long as they are respectively joined to one another electrically.

FIG. 2 is a front view showing the heat generating element 2 in the heat generating unit of embodiment 1.

The heat generating element 2 used in embodiment 1 is formed by cutting a film sheet, and has a structure in which wide width portions 2A and narrow width portions 2b are alternately disposed sequentially in the longitudinal direction. As shown in FIG. 2, the heat generating element 2, used in the heat generating unit of embodiment 1, has a so-called fish-bone (fish skeleton) shape.

The heat generating element 2 of embodiment 1 has a thickness (t) of 100 μm, a maximum width (W1) of 6 mm, a minimum width (W2) of about 2 mm and a length (L) of 250 mm (see FIG. 1). The length and the width of the heat generating element 2 are determined depending on an input voltage, a heat-generation temperature and the like, and can be altered on demand in accordance with the specification of the heat generating unit to be used as a heat source.

The heat generating element 2 of embodiment 1 has a structure including a portion through which a current flows by applied power to generate heat (hereinafter, this portion is referred to as a power-applied heat-generating portion 20) and a portion which generates heat with thermal conduction from the power-applied heat-generating portion 2C (hereinafter, this portion is referred to as a conducted heat-generating portion 2D). The heat generating element configured as described above has the same thermal conductivity in a plane direction, that is, a so-called two dimensional isotropic thermal conductivity. In the case where the thermal conductivity of the heat generating element is less than 200 W/m·K, that is, the two dimensional isotropic thermal conductivity is poor, heat conduction from the power-applied heat-generating portion 2C to the conducted heat-generating portion 2D becomes smaller. As a result, the temperature difference between the power-applied heat-generating portion 2C and the conducted heat-generating portion 2D becomes larger, with the result that temperature irregularities occur in the heat generating element.

The heat generating element 2, used in the heat generating unit of embodiment 1 in accordance with the present invention, is mainly composed of a carbon-based substance, has a structure in which a plurality of film sheet materials are laminated with a void formed between the respective layers in the thickness direction so as to have superior two dimensional isotropic thermal conduction, and is formed by a material with a film sheet shape having a thermal conductivity of 200 W/m·K or more. Therefore, the heat generating element 2, which has the power-applied heat-generating portion 2C and the conducted heat-generating portion 2D, forms a heat source without temperature irregularities because of heat generation and heat conduction thereof.

The film sheet material that is a material for the heat generating element 2 is a highly oriented graphite film sheet having a heat resistant property, formed by heating a polymer film or a polymer film with a filler added thereto at a high temperature, for example, in an atmosphere of 2400° C. or more, to be fired into graphite, and has a thermal conductivity of 600 to 950 W/m·K in its plane direction. In the case of a film sheet obtained through processes in which powder mainly made from natural graphite is molded and fired and then formed into a film sheet shape through a rolling process, the sheet generally has a thermal conductivity of 200 to 400 W/m·K; however, the heat generating element 2 used in embodiment 1 of the present invention has a superior two dimensional isotropic thermal conductive property with a thermal conductivity of 600 to 950 W/m·K in its plane direction, as described above.

The two dimensional isotropic thermal conductive property as used herein refers to thermal conduction that is exerted in all directions, within a face defined by the orthogonal X-axis and Y-axis. Therefore, the two dimensional isotropic property of the present invention is not intended to be limited only by one direction (X-axis direction) of carbon fiber directions in a heat generating element in which, for example, the carbon fibers are formed side by side in the same direction, or by two directions (X-axis direction and Y-axis direction) of carbon fiber directions in a heat generating element formed by knitting the carbon fibers in crossing directions.

The film sheet material serving as the material for the heat generating element 2 used in the present invention has a laminated structure in which the layer surface in the plane direction has various facial shapes, such as a flat face, a concave/convex face or a waving face, with a void being formed between the respective opposing layers. In the laminated structure of this film sheet material, the image of the formation states of the voids formed between the respective layers is similar to a cross-sectional shape of a pie obtained through processes in which a pie dough is formed by bending the material so as to be overlapped with one after another a plurality of times (for example, several ten times, several hundred times) and the pie dough is baked. Consequently, the film sheet material that is the material for the heat generating element 2 of the present invention is allowed to have a superior two dimensional isotropic thermal conductive property in the thermal conductivity in its plane direction, as described earlier.

The polymer film used for the film sheet material produced as described above may be at least one kind of polymer film selected from the group consisting of polyoxadiazole, polybenzothiazole, polybenzobisthiazole, polybenzooxazole, polybenzobisoxazole, polypyromellitic imide (pyromellitic imide), polyphenylene isophthalic amide (phenylene isophthalic amide), polyphenylene benzoimidazole (phenylene benzoimidazole), polyphenylene benzobisimidazole (phenylene benzobisimidazole), polythiazole and polyparaphenylenevinylene. Moreover, the material for the filler to be added to the polymer film include: phosphoric acid ester-based, calcium phosphate-based, polyester-based, epoxy-based, stearic acid-based, trimellitic acid-based, metal oxide-based, organic tin-based, lead-based, azo-based, nitroso-based and solfonylhydrazide-based compounds. More specifically, examples of phosphoric acid ester-based compounds include: tricresyl phosphate, (trisisopropylphenyl)phosphate, tributyl phosphate, triethyl phosphate, trisdichloropropyl phosphate and trisbutoxyethyl phosphate. Examples of calcium phosphate-based compounds include: calcium dihydrogen phosphate, calcium hydrogen phosphorous and calcium triphosphate. Examples of polyester-based compounds include: polymers and the like between adipic acid, a zelaic acid, sebacic acid as well as phthalic acid and glycols as well as glycerins. Moreover, examples of stearic acid-based compounds include: dioctyl sebacate, dibutyl sebacate, and acetyltributyl citrate. Examples of metal oxide-based compounds include: calcium oxide, magnesium oxide and lead oxide. Examples of trimellitic acid-based compounds include: dibutyl fumarate and diethyl phthalate. Examples of lead-based compounds include: lead stearate and lead silicate. Examples of azo-based compounds include: azodicarboxylic amide and azobisisobutylonitrile. Examples of nitroso-based compounds include: nitrosopentamethylene tetramine and the like. Examples of solfonylhydrazide-based compounds include: p-toluenesulfonyl hydrazide.

The film sheet materials are laminated, and subjected to a heating treatment at 2400° or more in an inert gas, and by adjusting the pressure in the gas treatment atmosphere generated during the graphite-forming process, a heat generating element having a film sheet shape is produced. Moreover, if necessary, by subjecting the film-sheet shaped heat generating element to a rolling process, a film-sheet shaped heat generating element having a better quality can be obtained. The film-sheet shaped heat generating element thus manufactured is used for a heat generating element 2 in the heat generating unit of the present invention.

Note that the amount of addition of the filler is preferably set in a range from 0.2 to 20.0% by weight, and more preferably, from 1.0 to 10.0% by weight. The optimal amount of addition differs depending on the thickness of a polymer material, and in the case where the thickness of the polymer material is thin, the amount of addition is set to a larger amount, while in the case where the thickness is thick, the amount of addition may be set to a smaller amount. The role of the filler is to keep the film after the heating treatment in a uniform foamed state. In other words, the added filler generates a gas during the heating process, and voids resulting from the gas generation serve as passages so that decomposition gases from the film inner portion are allowed to gently pass therethrough. Thus, the filler is effectively used for forming the uniformly foamed state.

The film sheet material, produced as described above, is generally processed into a desired shape by a punching mold of Thomson type or a laser machining process. In the case where, as one example of the laser machining process, a laser machining process mainly using a heat machining function of a CO₂ laser (wavelength: 10,600 nm) or the like is used with a thermal conductivity in a plane direction of the heat generating element 2 being set to 200 W/m·K or more, the heat is absorbed by the heat generating element to cause a failure to carry out the machining process. However, in the case where a laser machining process mainly using a non-heat machining function, such as a laser machining process using a wavelength from 1064 to 380 nm, for example, a short-wavelength laser machining process having a nominal length of 1064 nm, is used, it becomes possible to carry out a preferable machining process to obtain a desired shape with high precision.

In particular, upon forming the heat generating element 2 of embodiment 1, the inventors have confirmed that, by using the second high harmonic wave laser process with a nominal wavelength of 532 nm, a preferable machining process can be carried out with high precision. The material for the heat generating element 2 of embodiment 1 is a film sheet material, that is, a highly oriented graphite film sheet having a heat resistant property formed by heating a polymer film or a polymer film with a filler added thereto at a high temperature, for example, in an atmosphere of 2400° C. or more, to be fired into graphite. Moreover, the material forming the heat generating element 2 has a thermal conductivity of 600 to 950 W/m·K in its plane direction. In the case where the heat generating element 2 made from such a material is processed into a complicated shape, such as a shape having the thickness (t) of 100 μm, the maximum width (W1) of 6 mm, the minimum width (W2) of about 2 mm and the length (L) of 250 mm, the second high harmonic wave laser process with a nominal wavelength of 532 nm is preferably used. As described above, as the laser wavelength in the laser machining process becomes shorter, the thermal treatment becomes closer to a chemical treatment so that the effects of heat to the heat generating element 2 becomes smaller, and the generations of soot and burrs due to the treatment can be reduced, thereby making it possible to carry out a machining process with high precision. However, all the outer shapes of the heat generating element 2 are not necessarily required to be subjected to the laser machining process, and only either one of the wide width portion and the narrow width portion may be subjected to the laser machining process. For example, in the case where the wide width portion is determined by the element shape, only the narrow width portion may be subjected to the laser machining process, and needless to say, these processes may be properly selected on demand depending on the material shape or the like of the heat generating element.

Moreover, needless to say, the laser machining method may be selected on demand from machining methods having a laser machining wavelength (from 1069 to 380 nm) mainly utilizing the aforementioned non-heat machining function, depending on the material of the heat generating element 2, that is, the thermal conductivity in a plane direction and the shape. Furthermore, needless to say, the above-mentioned laser machining method used for processing the above-mentioned heat generating element 2 may be adopted in a heat generating unit of another embodiment to be described later, so as to carry out a hole-forming process of an area of the wide width portion of the heat generating element 22 shown in (b) of FIG. 4 or a cutting-in process or the like shown in (e) of FIG. 4.

Hereinafter, a specific structure of the heat generating unit in accordance with embodiment 1 will be described.

Each of the holding blocks 3 attached to the two ends of the heat generating element 2 has a substantially column shape, and is divided into two semi-column shapes. The heat generating element 2 is placed between the inner wall faces serving as the opposing faces of the semi-column-shaped holding blocks 3 divided into two portions, and the coil portion 5 of the first internal lead wire member 11A or the second internal lead wire member 11B is wound around the outer circumferential face of the holding block 3 so that the heat generating element 2 is held therein. With this arrangement, the holding blocks 3 support the two end portions of the heat generating element 2, while being electrically connected thereto. The holding blocks 3 made from a conductive material dissipate heat of the heat generating element 2 so that it exerts a heat releasing effect so as not to transmit high temperature to the coil portion 5 of the first internal lead wire member 11A or the second internal lead wire member 11B. For example, graphite is preferably used as the material for the holding blocks 3. However, any material may be used as the material for the holding blocks 3, as long as it is a material having a superior conductive property, such as a metal material. Moreover, the shape of the holding blocks 3 is not limited to a column shape, but may be formed into a shape such as a rectangular shape so as to be easily produced. Furthermore, the holding blocks 3 may have a shape in which the heat radiating effect is enhanced, for example, such a shape as to have a cooling fin or the like.

In embodiment 1, as has been described by the structural example having two divided holding blocks 3, a structure having a plurality of divided holding blocks so as to hold the heat generating element may be used, or a single integrated member, with slits, each having a thickness of each of the heat generating elements, being formed so that the heat generating elements 2 can be inserted therein, may be used with the same effects.

In embodiment 1 shown in FIG. 1, the holding blocks 3 are designed so that the heat generating element 2 is held by the inner wall faces of the holding blocks 3 divided into two portions; however, by forming a convex portion on one of the inner wall faces, it becomes possible to further increase the holding strength.

FIG. 3 is a partially exploded side view showing a portion near the holding block 3A that forms one example of a structure in which the holding strength is enhanced. The film sheet shaped heat generating element 2 shown in FIG. 3 has a structure in which a heat resistant member 12 is sandwiched on one of the sides of the inner wall faces.

The heat generating element 2 is a member having elasticity in the thickness direction. Therefore, the heat generating element 2 having the above-mentioned structure is depressed by the opposing face of the holding block 3A so that the heat generating element 2 is deformed within its elastic range to form concave/convex portions. As a result, even when the heat generating element 2 generates a large contraction force due to a high temperature, the heat resistant member 12 serves as a wedge against the heat generating element 2 so that it is possible to reliably prevent the heat generating element 2 from coming off from the holding block 3A. Moreover, another structure may be prepared in which a convex portion or a concave/convex portion having a size not more than the thickness of the heat generating element 2 is formed at least one portion of the opposing inner wall face of the holding block 3A. With this arrangement, it becomes possible to prevent the heat generating element 2 from coming off from the holding block 3A.

In the heat generating unit of embodiment 1 having the above-mentioned structure, when power is supplied to the external lead wires 9 drawn out from the two sides thereof, a current is allowed to flow through the heat generating element 2 so that heat is generated by the resistance of the heat generating element 2. At this time, since the heat generating element 2 is mainly made from a carbon-based substance, infrared rays are emitted from the heat generating element 2.

By changing the surface shape of the heat generating element 2 in the heat generating unit of embodiment 1, the heat radiating state thereof can be changed. For example, even when the heat generating unit is formed by the same film sheet material, radiating energy thereof can be increased by reducing the thickness, with the width being widened, even in the case where no change is made on the resistance value.

As described earlier, the dimensions of the heat generating element 2 (see FIG. 2) of embodiment 1 are set with the thickness (t) of 100 μm, the maximum width (W1) of 6 mm, the minimum width (W2) of about 2 mm and the length (L) of 250 mm (see FIG. 1). The belt-shaped portion with the minimum width (W2) corresponds to a power-applied heat-generating portion 2C through which a current flows to generate heat in the heat generating element 2. Moreover, a protruding portion of the heat generating element 2 located outside of the power-applied heat-generating portion 2C corresponds to a conducted heat-generating portion 2D that releases heat from the power-applied heat-generating portion 2C.

The belt-shaped heat generating element 2 that is extended in the longitudinal direction is preferably designed so as to have a ratio of 5/1 or more between the length in the width direction and the length in the thickness direction. The length in the width direction is made five times or more larger than the length in the thickness direction so that the quantity of heat released from the surfaces forming the width direction is made substantially larger than the quantity of heat released from the surfaces forming the thickness direction; thus, it becomes possible to utilize the heat generating element 2 as a heat source having high directivity.

The heat generating element 2, which is mainly composed of a carbon-based substance and configured by using a film sheet-shaped material having a two dimensional isotropic thermal conductive property, has a positive characteristic (PTC) in which the resistance value increases as the temperature becomes higher, with a high heat-generating efficiency being exerted. For this reason, the time required for achieving a rated temperature from the start of heating is extremely short. Therefore, although a rush current occurs upon lighting on, the rush current is just two times as high as the equilibrium current although it depends on the temperature in the equilibrium state, and such a rush current as 10 times as high, as in the case of a heat generating element made of a tungsten wire is not generated. Therefore, the heat generating element 2 in the heat generating unit of embodiment 1 has a characteristic that hardly causes flickers. Moreover, the life of the heat generating element 2 is about 10000 hours although it depends on the service temperature of the heat generating element 2. The life is about two times longer than that of a heat generating element made of a tungsten wire.

At least one kind of polymer film particularly selected from the aforementioned film sheet materials, or the polymer film to which the aforementioned filler is added, is subjected to a heating treatment at 2400° C. or more in an inert gas, and the pressure in the gas treatment atmosphere generated during the graphite-forming process is controlled. By carrying out these controlling processes, it is possible to produce a heat generating element 2 that has a two-dimensional isotropic thermal conductive property and a positive characteristic (PTC) in which the resistance value increases as the temperature becomes higher in the temperature characteristic. The heat generating element 2 produced in this manner makes it possible to ensure stability in the generated temperature, and also to provide a stable heat source with high reliability that can carry out a stable self-input controlling operation in response to a thermal variation, in the case where an input voltage is supplied as a constant voltage.

FIG. 4 is a view showing another structural example of a heat generating element in the heat generating unit of embodiment 1. In (a) to (i) of FIG. 4, since the heat generating element has an elongated shape, only the portion connected to one of the holding blocks 3 is shown, with a portion connected to the other holding block 3 being omitted.

In (a) of FIG. 4, a heat generating element 21, shown as a front view, has a belt shape having a rectangular shape, with a length in the width direction being made constant, and a current I flowing through the heat generating element 21 is allowed to flow uniformly in the width direction of the heat generating element 21 so that the surface of the heat generating element 21 is allowed to generate heat uniformly.

The heat generating element 22, shown as a front view in (b) of FIG. 4, has a shape in which a hole is formed in an area of a wide width portion 2A of the heat generating element 2 shown in FIG. 2 so that a power-applied heat generating passage is formed on the peripheral portion so that the current is allowed to flow to the end portion of the wide width portion 2A. In other words, in the heat generating element 22 shown in (b) of FIG. 4, the power-applied heat generating passage is made longer even in the limited length of the heat generating unit. The heat generating element 22 having such an arrangement makes it possible to improve the degree of freedom in designing, such as an input power, temperature, size and the like.

The shape of the heat generating element 23, shown in a front view of (c) of FIG. 4, has a structure in which a plurality of holes are formed in one row in the longitudinal direction on a heat generating element having an elongated belt shape. With this structure, the heat generating element 23 has a shape in which two portions that communicate with each other in the longitudinal direction of the heat generating element 23 are formed, that is, two passages are prepared as the power-applied heat generating passages. Because of this structure, the heat generating element 23 is superior in its shape retaining property, and can be easily handled without causing a twisted state and a rupture.

Note that the positions of the holes to be formed are not limited to one row, and a plurality of positions of the holes may be prepared by taking into consideration an object to be heated and the specification and the like of an apparatus in which it is assembled; moreover, a plurality of holes, formed in a plurality of rows or at random, may be prepared.

The shape of each hole is not necessarily formed into a round shape as shown in (c) of FIG. 4, and may be formed into a pattern that indicates a specification, standard or logo of the corresponding heat generating element and the like as a shape of holes, without causing any influences to the effects of the present invention.

The shape of a heat generating element 24, as shown by a perspective view in (d) of FIG. 4, is a modified shape of the conducted heat-generating portion 2D of the heat generating element 2 in FIG. 2. The conducted heat-generating portion 2D of the heat generating element 2 of FIG. 2 has a tongue shape, with a tip portion being a round shape; however, the heat generating element 24 in (d) of FIG. 4 differs only in that the tip portion of a conducted heat-generating portion 24A has a rectangular shape. Therefore, the heat generating element 24 of (d) of FIG. 4 has the same effects as the heat generating element 2 of FIG. 2.

The shape of a heat generating element 25, as shown by a perspective view in (e) of FIG. 4, is a modified shape in which cut-in portions 25A are formed in the two sides of the belt-shaped heat generating element 21 shown in (a) of FIG. 4. With this structure, the center portion is allowed to serve as a power-applied heat-generating portion, with the portions with the cut-in portions on the two sides serving as conducted heat-generating portions, so that it is possible to form a large heat-generating area with a small current by using a simple structure.

The shape of a heat generating element 26, as shown by a perspective view in (f) of FIG. 4, is a modified shape in which one portion of the conducted heat-generating portion is bent in the heat generating element 25 shown in (e) of FIG. 4. In the heat generating element 26 in (f) of FIG. 4, every other conducted heat-generating portion 26A is bent forward or rearward at right angles (in upward direction or downward direction in (f) of FIG. 4) in the thickness direction of the heat generating element 26. In accordance with the heat generating element 26 thus formed, heat radiation can be exerted also in the thickness directions of the heat generating element 26.

The shape of a heat generating element 27, as shown by a perspective view in (g) of FIG. 4, is a modified shape in which one portion of the conducted heat-generating portion of the heat generating element 25 shown in (e) of FIG. 4 is cut and raised up to form a cut and raised portion 27A. With this structure, it becomes possible to prevent adjacent conducted heat-generating portions from coming into contact with each other, in comparison with the heat generating element 25 shown in (e) of FIG. 4. In the same manner as in the heat generating element 25 of (e) of FIG. 4, the center portion is allowed to serve as a power-applied heat-generating portion, with the cut and raised portions 27 on the two sides serving as conducted heat-generating portions. In this manner, it is possible to form a large heat-generating area with a small current by using a simple structure shown in (g) of FIG. 4.

The shape of a heat generating element 28, as shown by a perspective view in (h) of FIG. 4, is a modified shape in which tongue-shaped cut and raised portions 28A are formed in the center portion of the belt-shaped heat generating element 21 shown in (a) of FIG. 4 with constant intervals. Note that the shape of each tongue-shaped cut and raised portion 28A is not limited to the tongue shape, and any cut and raised shape may be used as long as the conducted heat-generating portions can be formed. With this structure, the two side portions are allowed to serve as power-applied heat-generating portions, with the center portion serving as a conducted heat-generating portion so that it becomes possible to improve the degree of freedom in designing, such as the input power, temperature, size and the like.

Moreover, in the same manner as in the heat generating element 23 shown in (c) of FIG. 4, the heat generating element 28 shown in (h) of FIG. 4 is superior in its shape retaining property, and can be easily handled without causing a twisted state and a rupture.

The heat generating element 29 shown in (i) of FIG. 4 is formed into a shape in which cut-in portions 29A are formed alternately from the two sides. In the heat generating element 29, the length of the power-applied heat-generating portion is made as long as possible in the limited length of the heat generating unit, and this arrangement makes it possible to improve the degree of freedom in designing, such as the input power, temperature, size and the like.

In the heat generating unit in accordance with embodiment 1 of the present invention, a heat generating element, which is mainly composed of a carbon-based substance, is made into a film-sheet shape, and has substantially the same thermal conductivity in a plane direction, that is, a so-called two dimensional isotropic thermal conductivity. In particular, the heat generating unit of embodiment 1 uses a heat generating element that is formed into a film-sheet shape having a thermal conductivity of 200 W/m·K or more, with a thickness of 300 or less. For this reason, the heat generating unit of embodiment 1 makes it possible to generate heat uniformly. Moreover, in the heat generating unit of embodiment 1, since the heat generating element has pliability, flexibility and elasticity, it is possible to carry out machining processes, such as cutting out, hole-forming, bending, and cutting and raising processes, thereon, so that the heat generating element is allowed to have a high degree of freedom in designing.

In the above-mentioned embodiment 1, a description has been given by exemplifying a structure in which the heat generating element is inserted in a transparent quartz glass tube, with a gas being sealed in the glass tube, and used under a high temperature. However, a container other than the glass tube may be used for the heat generating element in the heat generating unit of the present invention. The film-sheet-shaped heat generating element, which is mainly composed of a carbon-based substance, and has two dimensional isotropic thermal conduction and properties, such as pliability, flexibility and elasticity, with a thermal conductivity of 200 W/m·K or more and a thickness of 300 μM or less, has an amount of oxidation smaller than that of other carbon-based materials for the heat generating element, not only when used under a high temperature (about 1100° C.), but also when used around 800° C., so that the resulting composition structure is sufficiently durable for practical use. This is because the film-sheet-shaped heat generating elements are closely molded. Therefore, the material for the container for the heat generating element can be selected in association with the service temperature of the heat generating element. For example, when the heat generating element is used at 180° C. or less, a container made from a silicon material may be used, and when used at 250° C. or less, a container made from a fluorine resin may be used, while, when used at 800° C. or less, the insulating material may be selected from materials, such as a mica material, ceramics, crystallized glass, a quartz tube and heat resistant glass, within a permissible range of heat resistant temperatures. It is not necessary to fill the container with a gas under the service temperature of 800° C. or less, and the structure and shape of the heat generating unit can be designed freely in accordance with service objectives. Thus, in the case of the heat generating unit to be used under the service temperature of 800° C. or less, it becomes possible to greatly widen the degree of freedom in designing, and also to reduce the costs.

Note that, with respect to the tube shape in embodiment 1, a description has been given as a substantially round shape in its cross section; however, the present invention is not limited to the substantially round shape, and a square shape or a polygonal shape, such as a hexagonal shape, may be used in accordance with the specification and objectives of the heat generating unit; moreover, an elliptical shape may be used with the same effects as those of the heat generating unit of embodiment 1.

Moreover, in the heat generating unit of embodiment 1 of the present invention, needless to say, since the heat generating element has superior pliability, flexibility and elasticity, the heat generating unit can be formed into a tube shape, a rectangular shape, a curved shape with a bent portion being formed in the longitudinal direction, an annular shape with a round portion, and the like.

### Embodiment 2

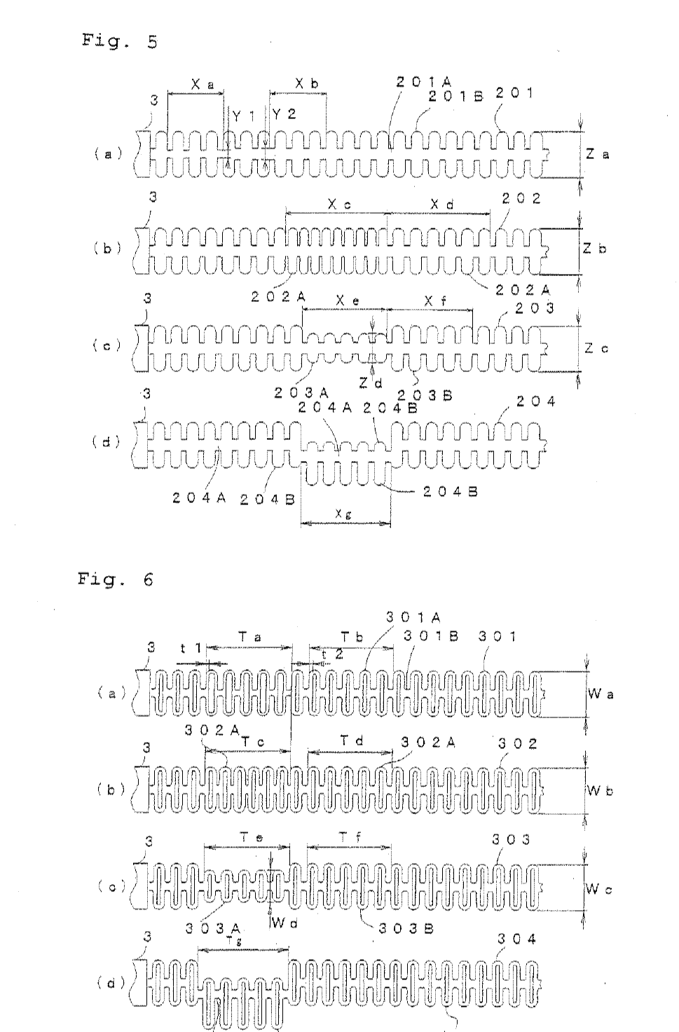

Hereinafter, heat generating units in accordance with embodiment 2 of the present invention will be described with reference to (a) to (d) of FIG. 5. (a) to (d) of FIG. 5 are front views that show specific examples of heat generating elements having various shapes for the heat generating units of embodiment 2. In each of the heat generating elements of (a) to (e) of FIG. 5, the heat generating element has an elongated shape with the same patterns being repeated thereon, thereby the portion on the right side is not shown in each of the figures.

The heat generating units of embodiment 2 are different from the heat generating units of embodiment 1 only in the shapes of the heat generating elements, and the other portions are the same as those of embodiment 1. Therefore, descriptions will be given on the shapes of the heat generating elements in the heat generating units of embodiment 2, and the descriptions of embodiment 1 will be applied to the other structural components.

In each of the heat generating elements of the heat generating units of embodiment 2, an attempt is made not to make the temperature distributions in the longitudinal direction and the width direction of the heat generating element uniform, but to make the temperature distributions different from each other. In each of the heat generating elements of the heat generating units of embodiment 2, an area having a different resistance value per unit length is formed in at least one portion in the length direction. The heat generating element of embodiment 2 is a modified example of the heat generating element 2 that has been described with reference to FIG. 2 in embodiment 1. (a) to (d) of FIG. 5 show various modified examples of the heat generating elements of embodiment 2.

In a heat generating element 201 shown in (a) of FIG. 5, the center portion thereof forms a power-applied heat-generating portion 201A, and a plurality of protruding tongue-shaped portions on the two sides (upper and lower portions of the power-applied heat-generating portion 201A in (a) of FIG. 5) form conducted heat-generating portions 201B. Wide width portions having the conducted heat-generating portions 201B are arranged side by side in the longitudinal direction with the same intervals, with the maximum width of the heat generating element 201, that is, the width of the wide width portion, being set to Za. All the wide width portions in the longitudinal direction have the same width.

As shown in (a) of FIG. 5, with respect to areas Xa and Xb having the same distance in the longitudinal direction in the heat generating element 201, the narrowest widths (Y1 and Y2) that correspond to the widths of the power-applied heat-generating portion 201A are made different from each other. In other words, the first narrowest width Y1 of the first area Xa is made narrower than the second narrowest width Y2 of the second area (Y1<Y2). In this manner, since the first narrowest width Y1 is made narrower than the second narrowest width Y2 (Y1<Y2), the resistance value in the first area Xa becomes greater than the resistance value in the second area Xb so that the heat generation temperature of the first area Xa becomes higher. In this manner, by forming the areas having different resistance values, it is possible to set a desired temperature distribution in the length direction of the heat generating element 201.

In a heat generating element 202 shown in (b) of FIG. 5, although the maximum width Zb of wide width portions 202A having conducted heat-generating portions is completely the same, the distance and the shape of the wide width portions 202A in the longitudinal direction are made different. In the heat generating element 202, the third area Xc and the fourth area Xd, each having the same length in the longitudinal direction, have the formed wide width portions 202A the numbers of which are made different from each other. In other words, the number of the formed wide width portions 202A in the third area Xc is made greater than the number of the formed wide width portions 202A in the fourth area Xd. In the example of (b) of FIG. 5, the number of the formed wide width portions 202A in the third area Xc is nine, while the number of the formed wide width portions 202A in the fourth area Xd is six. Moreover, the shape of the wide width portions 202A of the third area Xc is formed, with its width in the longitudinal direction being made narrower than that of the shape of the wide width portions 202A of the fourth area Xd, so that the third area Xc has a higher density of the wide width portions 202A than that of the fourth area Xd. In this manner, since the third area Xc and the fourth area Xd having different pattern densities are formed, the resistance value of the third area Xc becomes greater than the resistance value of the fourth area Xd so that the heat generation temperature of the third area Xc becomes higher. In this manner, by preparing areas having mutually different resistance values in the longitudinal direction of the heat generating element 202, it becomes possible to provide a desired temperature distribution in the longitudinal direction of the heat generating element 202.

In the heat generating element 202 shown in (b) of FIG. 5, areas other than the third area Xc are designed to have the same structure as that of the fourth area Xd; however, the layout of these area can be altered on demand depending on temperature distributions to be set.

In a heat generating element 203 shown in (c) of FIG. 5, the fifth area Xe and the sixth area Xf, each having the same distance in the longitudinal direction, have mutually different maximum widths. The maximum width Zd of the wide width portions 203A in the fifth area Xe is made narrower than the maximum width Zc of wide width portions 203B of the sixth area Xf (Zd<Zc). Additionally, the interval in the longitudinal direction of the wide width portions 203B of the fifth area Xe is the same as the interval in the longitudinal direction of the wide width portions 203B of the sixth area Xf. In this manner, by making the maximum width Zd narrower than that in the other areas (Zd<Zc) only in the fifth area Xe, the amount of heat generation in the sixth area Xf becomes greater than the amount of heat generation in the fifth area Xe so that the temperature in the sixth area Xf can be made higher than that in the fifth area Xe. In this manner, it becomes possible to provide a desired temperature distribution in the longitudinal direction of the heat generating element.

In a heat generating element 204 shown in (d) of FIG. 5, power-applied heat-generating portions 204A in the seventh area Xg are formed at positions deviated from the power-applied heat-generating portions 204A in the other areas (downward deviated positions, in (d) of FIG. 5). Moreover, in the seventh area Xg, conducted heat-generating portions 204B, formed on the two sides of each power-applied heat-generating portion 204, have shapes that are not symmetrically formed, each having a shape that expands upward with a small portion, and also expands downward with a large portion. In this manner, by shifting one portion of the areas of the heat generating element 204 to one side, it becomes possible to set the temperature distribution in the width direction of the heat generating element 209 together with the temperature distribution in the longitudinal direction.

Not limited to the pattern shapes shown in (a) to (e) of FIG. 5, the heat generating elements in accordance with the heat generating unit of the present invention may be modified into various shapes capable of altering the resistance value. Moreover, needless to say, by adding the aforementioned arrangements and the like shown in FIG. 4 to the heat generating element in embodiment 2, it becomes possible to alter the temperature distribution in the longitudinal direction to a desired state.

In particular, the heat generating element in the heat generating unit of the present invention, mainly composed of a carbon-based substance, has a two-dimensional isotropic thermal conductive property and superior pliability, flexibility and elasticity, and is formed into a film-sheet shape having a thermal conductivity of 200 W/m·K or more, with a thickness of 300 μm or less. For this reason, the heat generating element in the heat generating unit of the present invention makes it possible to carry out machining processes, such as cutting out, hole-forming, bending, and cutting and raising processes, thereon, so that the heat generating element is allowed to have a structure that can be altered on demand in accordance with the structure of the heat generating unit.

### Embodiment 3

Referring to (a) to (d) of FIG. 6, heat generating units in accordance with embodiment 3 of the present invention will be described. (a) to (d) of FIG. 6 are front views that show specific examples of heat generating elements having various shapes for the heat generating units of embodiment 3. In each of the heat generating elements of (a) to (e) of FIG. 6, since the heat generating element has an elongated shape with the same patterns being repeated thereon, the portion on the right side is not shown in each of the figures.

The heat generating unit of embodiment 3 differs from the heat generating unit of embodiment 1 in the shape of the heat generating element, the other structures are the same as those of embodiment 1. Therefore, the shape of the heat generating element in the heat generating unit of embodiment 3 will be described, and with respect to the other components, the descriptions of embodiment 1 will be applied.

In each of the heat generating elements of the heat generating units of embodiment 3, an attempt is made not to make the temperature distributions in the longitudinal direction and the width direction of the heat generating element uniform, but to make the temperature distributions different from each other. In each of the heat generating elements of the heat generating units of embodiment 3, an area having a different resistance value per unit length is formed at least one portion in the length direction. The heat generating element of embodiment 3 is a modified example of the heat generating element 22 that has been described with reference to (b) of FIG. 4 in embodiment 1. (a) to (d) of FIG. 6 show various modified examples of the heat generating elements of embodiment 3.

In a heat generating element 301 shown in (a) of FIG. 6, like the heat generating element 2 shown in FIG. 2, respective areas of wide width portions 301A and narrow width portions 301B are sequentially arranged alternately in the longitudinal direction. Moreover, a hole is formed through each of the areas of the wide width portions 301A so that an applied-power heat generating passage is formed on the periphery of each of the wide width portions 301A so as to allow a current to flow to the end portion of each wide width portion 301A. In other words, as shown in (a) of FIG. 6, the heat generating element 301 is designed so that the applied-power heat generating passage through which a current flows is made longer within the limited heat generating unit length.

In the heat generating element 301 shown in (a) of FIG. 6, the wide width portions 301A are disposed with equivalent intervals, with the maximum width being set to Wa. In the heat generating element 301 shown in (a) of FIG. 6, the first area Ta and the second area Tb, each having the same length in the longitudinal direction, have power-applied heat generating passages with mutually different shapes. The width t1 of the applied-power heat generating passage in the first area Ta is made narrower than the width t2 of the applied-power heat generating passage in the second area Tb (t1<t2). For this reason, the resistance value in the first area Ta becomes greater than the resistance value in the second area Tb. Since the same current flows through the first area Ta and the second area Tb, the heat generation temperature of the first area Ta becomes higher than the heat generation temperature of the second area Xb so that it becomes possible to provide a desired temperature distribution in the longitudinal direction of the heat generating element 301.

In a heat generating element 302 shown in (b) of FIG. 6, although the maximum width Wb of the wide width portions 302A is the same, the intervals of the wide width portions 302A are made different from each other in the longitudinal direction. In the heat generating element 302, the third area Tc and the fourth area Td, each having the same length in the longitudinal direction, have respectively formed wide width portions 302A the numbers of which are mutually different from each other. In other words, the number of the formed wide width portions 302A in the third area Tc is made greater than the number of the formed wide width portions 302A in the fourth area Td. In the example shown in (b) of FIG. 6, the number of the wide width portions 302A in the third area Tc is six, and the number of the wide width portions 302A in the fourth area Td is five. In this manner, in the heat generating element 302, since the number of the formed wide width portions 302A in the third area Tc is made greater, with the number of the formed wide width portions 302A in the fourth area Td being made smaller, the third area Tc and the fourth area Td having mutually different pattern densities are formed in the heat generating element 302. As a result, the resistance value of the third area Tc is made greater than the resistance value of the fourth area Td so that the heat generation temperature in the third area Tc becomes higher. In this manner, by forming areas having mutually different resistance values in the longitudinal direction on the heat generating element 302, it becomes possible to set a desired temperature distribution in the longitudinal direction of the heat generating element 302.

In the heat generating element 302 shown in (b) of FIG. 6, areas other than the third area Tc are designed to have the same structure as that of the fourth area Td; however, the layout of these area can be altered on demand depending on temperature distributions to be set.

In a heat generating element 303 shown in (c) of FIG. 6, the fifth area Te and the sixth area Tf, each having the same distance in the longitudinal direction, have mutually different maximum widths. The maximum width Wd of the wide width portions 303A in the fifth area Te is made narrower than the maximum width Wc of wide width portions 303B of the sixth area Tf (Wd<Wc). Additionally, the distance in the longitudinal direction of the wide width portions 303A of the fifth area Te is the same as the distance in the longitudinal direction of the wide width portions 303B of the sixth area Tf. In this manner, by making the maximum width Wc of the wide width portions 303A in the fifth area Te narrower than that in the other areas (Wd<Wc) in the fifth area Te, the amount of heat generation in the sixth area Tf becomes greater than the amount of heat generation in the fifth area Te so that the temperature in the sixth area Tf is made higher. In this manner, by providing areas having different resistance values in the longitudinal direction of the heat generating element 303, it becomes possible to provide a desired temperature distribution in the longitudinal direction of the heat generating element 303.

In a heat generating element 304 shown in (d) of FIG. 6, the wide width portions 304A in the seventh area Tg are formed at positions deviated from the wide width portions 304B in the other areas (downward deviated positions, in (d) of FIG. 6). Moreover, in the seventh area Tg, the length of the power-applied heat generation passages from the narrow width portion 304C in the wide with portions 304A are mutually made different between the two sides of the narrow width portion 304C (upper and lower portions in (d) of FIG. 6). In other words, the power-applied heat generation passage of the wide width portions 304A on the lower side from the narrow width portions 304C is made longer than the power-applied heat generation passage of the wide width portions 304A on the upper side from the narrow width portions 304C. In this manner, by shifting one portion of the areas of the heat generating element 304 to one side, it becomes possible to set the temperature distribution in the width direction of the heat generating element 304 together with the temperature distribution in the longitudinal direction.

Not limited to the pattern shapes shown in (a) to (e) of FIG. 6, the heat generating elements in accordance with the heat generating unit of the present invention may be modified into various shapes capable of altering the resistance value. Moreover, needless to say, by adding the aforementioned arrangements and the like shown in FIG. 4 to the heat generating elements in embodiment 3, it becomes possible to alter the temperature distribution in the longitudinal direction to a desired state.

### Embodiment 4

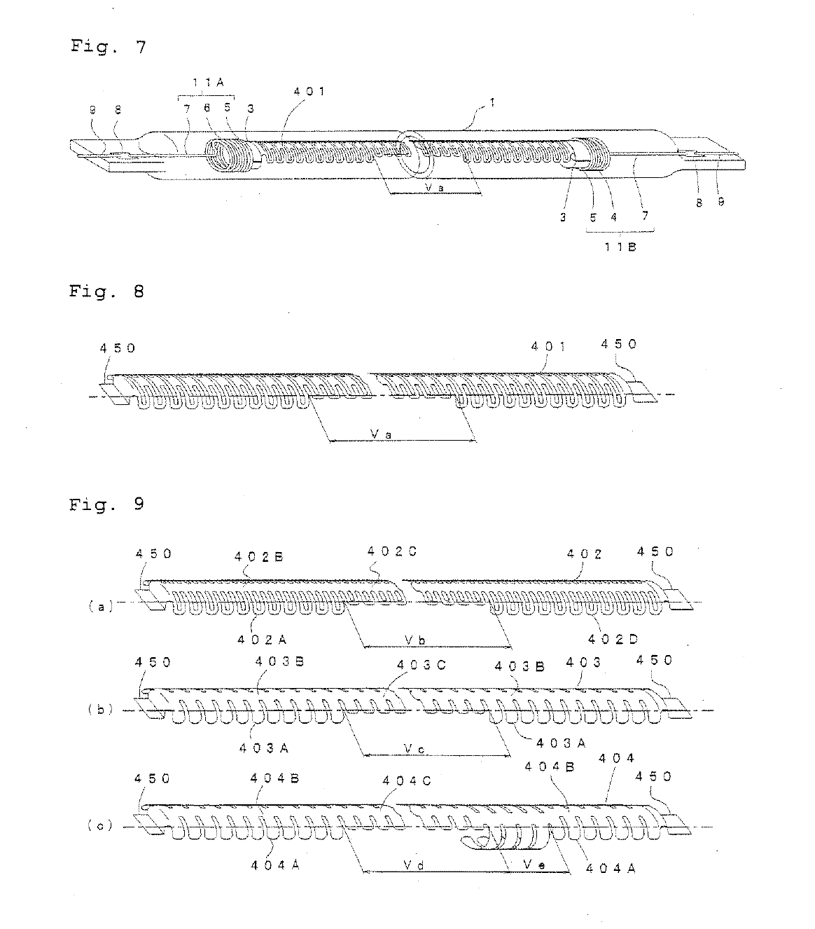

Hereinafter, heat generating units in accordance with embodiment 4 of the present invention will be described with reference to FIGS. 7 to 9.

FIG. 7 is a perspective view showing a structure of the heat generating unit of embodiment 4 in accordance with the present invention. FIG. 8 is a perspective view showing a heat generating element in the heat generating unit of embodiment 4. (a) to (c) of FIG. 9 are perspective views that show other structural examples of the heat generating element ih the heat generating unit of embodiment 4.

The heat generating units of embodiment 4 are different from the heat generating units of embodiment 1 in the shapes of the heat generating elements, and in that the heat generating elements have curved faces. In the heat generating units of embodiment 4, those heat generating elements, described in embodiment 1, the widths of which are further widened are utilized. In order to insert each of the heat generating elements of embodiment 4 into a quartz glass tube serving as a heat resistant tube, at least one portion of each heat generating element in its cross-sectional shape in a direction (width direction) orthogonal to the longitudinal direction is formed into a curved face so that the heat generating element, even if it has a wide width, can be easily housed in the heat resistant tube.

As shown in FIG. 7, in the same manner as in the heat generating unit of embodiment 1, the heat generating unit of embodiment 4 is provided with a heat generating element 401 having an elongated flat plate shape, which serves as a heat radiator, and holding blocks 3 that are secured onto the two ends of the heat generating element 401. A first internal lead wire member HA is attached to one of the holding blocks 3 (holding block 3 on the left side in FIG. 7), and a second lead internal lead wire member 11B is attached to the other holding block 3 (holding block 3 on the right side in FIG. 7). Each of the first internal lead wire member 11A and second internal lead wire member 11B is electrically connected to an external lead wire 9 that is drawn out of each of the two ends of a glass tube 1 through a molybdenum foil 8 embedded into each of fused portions of the two ends of the glass tube 1.

In the heat generating unit of embodiment 4, since those members that are other than the heat generating element in the heat generating unit of embodiment 1 have the same structures as those of embodiment 1, those members having the same functions and structures as those of embodiment 1 are indicated by the same reference numerals, and the same detailed descriptions as those of embodiment 1 are applied thereto.

As shown in FIG. 8, the heat generating element 401 in the heat generating unit of embodiment 4 has a structure in which the heat generating element 303 as described in (c) of FIG. 6 in embodiment 3 is designed to have curved faces. In the heat generating element 401, the cross-sectional shapes in a direction orthogonal to the longitudinal direction are formed into arc shapes. A flat supported holding end portion 450 is formed on each of the two ends of the heat generating element 401. The supported holding end portions 450 correspond to portions that are held and supported by the holding blocks 3 divided into two portions. Moreover, the heat generating element 401 has an area Va having a narrow width in the maximum width in comparison with the other areas, which is formed in substantially center portion thereof in the longitudinal direction. Therefore, the amount of heat generation of the area Va per unit length in the longitudinal direction is made smaller in comparison with the amount of heat generation in the other areas so that the heat generation temperature in the center portion is set in a low level. In this manner, by forming an area having a different resistance value, this structure makes it possible to set a desired temperature distribution in the longitudinal direction of the heat generating element 901. Moreover, since the cross-sectional shapes in a direction orthogonal to the longitudinal direction are formed into curved faces in the heat generating element 401 of embodiment 4, heat radiation from the heat generating element 401 can be concentrated, or diffused. Even in the case where, in embodiment 4, the diameter of the heat resistant tube using a glass tube 1 is large relative to that of the heat generating element 401, by installing the heat generating element 401 formed into curved faces in the corresponding heat resistant tube, the concentrating or diffusing function of the heat radiation from the heat generating element 401 can be exerted. Moreover, by forming at least one portion of the heat generating element 401 into curved faces, the concentrating or diffusing function may be exerted partially.

Heat generating bodies 402, 403 and 404, shown in (a), (b) and (c) of FIG. 9, are modified examples of the heat generating element 401 in embodiment 4. In the same manner as the heat generating elements 401 shown in FIG. 8, each of the heat generating elements 402, 403 and 404 has the cross-sectional shape in a direction orthogonal to the longitudinal direction formed into an arc shape, with the flat supported holding end portions 450 being formed on the two ends.

In the heat generating element 402 shown in (a) of FIG. 9, wide width portions 402A and narrow width portions 402b are sequentially formed alternately so that a belt-shaped applied-power heat-generating portion 402C is formed in the center portion in the longitudinal direction of the heat generating element 402. A hole is formed through each of tongue-shaped portions 402D in the wide width portions 402A formed on the two sides of the applied-power heat-generating portion 402C so that an applied-power heat generating passage is formed so as to allow a current to flow to the end portion of each of the tongue-shaped portions 402D.

Moreover, the heat generating element 402, shown in (a) of FIG. 9, has an area Vb having a narrow width in the maximum width in comparison with the other areas, which is formed in substantially center portion thereof in the longitudinal direction. Therefore, the amount of heat generation of the area Vb is made smaller in comparison with the amount of heat generation in the other areas so that the heat generation temperature in the center portion is set in a low level; thus, it becomes possible to set a desired temperature distribution in the longitudinal direction of the heat generating element 402.

In the heat generating element 403 shown in (b) of FIG. 9, wide width portions 403A are formed with equivalent intervals, with a narrow width portion 403B sandwiched therebetween, so that a belt-shaped applied-power heat-generating portion 403C is formed in the center portion in the longitudinal direction of the heat generating element 403. Moreover, in the heat generating element 403 shown in (b) of FIG. 9, an area Vc having a narrow width in the maximum width in comparison with the other areas is formed in substantially center portion thereof in the longitudinal direction. Therefore, it becomes possible to set a desired temperature distribution in the longitudinal direction of the heat generating element 403.

In the heat generating element 404 shown in (c) of FIG. 9, wide width portions 404A are formed with equivalent intervals, with a narrow width portion 404B sandwiched therebetween. Moreover, in the heat generating element 404 shown in (c) of FIG. 9, areas with wide width portions 404A having mutually different shapes are formed as the areas in the longitudinal direction. As shown in (c) of FIG. 9, in an area Vd, the length of tongue-shaped portions of the wide width portions 404A is made shorter than that in the other areas. Moreover, in an area Ve adjacent to the area Vd, the position of the applied-power heat-generating portion 404C is formed at a position shifted from that of the other portions. Moreover, the lengths of the tongue-shaped portions on the two sides of the applied-power heat-generating portion 404C in the wide width portion 404A of the area Ve are made different from each other. More specifically, in the heat generating portion 404 shown in (c) of FIG. 9, the tongue-shaped portions on the front side of the wide width portion 404A of the area Ve are made longer, and formed into substantially a semi-arc shape along the inner wall face of the heat resistant tube, for example, a quartz glass tube. In contrast, the tongue-shaped portions on the rear side of the wide width portion 404A of the area Ve are made shorter. Therefore, it is possible to set a desired temperature distribution in the longitudinal direction of the heat generating element 404 as well as in a circumferential direction orthogonal to the longitudinal direction.

The heat generating element in the heat generating unit in accordance with embodiment 4 of the present invention is mainly composed of a carbon-based substance and has a film-sheet shape. Therefore, the heat generating element in the heat generating unit of embodiment 4 has a so-called two dimensional isotropic thermal conductivity that exerts substantially the same thermal conductivity in a plane direction. Since the heat generating element in the heat generating unit of embodiment 4 is made from a material that has superior pliability, flexibility and elasticity, and can be machined with high precision, various modifications can be made as shown by the heat generating elements used in embodiment 4. In the heat generating elements in embodiment 4, in the case where the maximum width is larger than the inner diameter of the heat resistant tube, a curved face can be formed so that the heat generating element may be disposed along the inner wall face of the heat resistant tube. Moreover, even in the case where the maximum width is smaller than the inner diameter of the heat resistant tube, the heat generating elements having various shapes with curved faces as described in embodiment 4 can be used for the purpose of concentration and diffusion of heat radiation from the heat generating elements.

In the heat generating unit of embodiment 4, by forming curved portions in the heat generating element, the shape (diameter) of a heat resistant tube used for housing the heat generating element is made free from regulations caused by the shape of the heat generating element. As a result, the heat generating unit of the present invention has a structure capable of variably changing a heat capacity; thus, for example, by miniaturizing the heat resistant tube without changing the heat generating element to make the heat capacity smaller, it is possible to start the temperature rise earlier so that designing processes suitable for purposes can be carried out.

Moreover, by disposing the heat generating element close to the inner wall face of the heat resistant tube, it is possible to raise the inner wall temperature of the heat resistant tube and consequently to increase heat radiation from the heat resistant tube.

Furthermore, the heat generating element formed with curved faces may be inserted in a heat resistant tube, with the pattern shape in the longitudinal direction and the pattern shape in the width direction being combined with each other, so that a heat generating unit is formed; thus, it becomes possible to properly set not only the temperature distribution in the longitudinal direction, but also the temperature distribution in the circumferential direction. As a result, the present invention makes it possible to form a three-dimensional temperature distribution, and consequently to greatly widen the service range of the heat generating unit of the present invention. In the conventional heat generating unit, the three-dimensional temperature distribution is formed by using a plurality of heat generating units; however, in accordance with the present invention, the same structure can be formed by using only one heat generating unit so that it is possible to save space and also to reduce costs.

### Embodiment 5

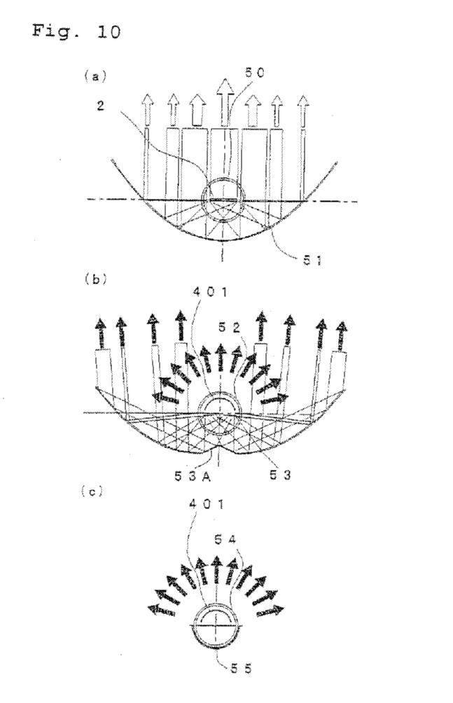

Hereinafter, a heating apparatus in accordance with embodiment 5 of the present invention will be described with reference to (a) to (c) of FIG. 10.

In the heating apparatus of embodiment 5, the heat generating units of embodiments 1 to 4 are used as heat radiating sources. (a) to (c) of FIG. 10 are views that show structures in which the heat generating units of the present invention are used as the heat radiating sources, with a reflective plate or a reflective film being formed therein. (a) to (c) of FIG. 10 are cross-sectional views taken in a direction orthogonal to the extending direction of the heat generating unit.

Referring to (a) to (c) of FIG. 10, an example of the heating apparatus of embodiment 5 is described. The heating apparatus shown in (a) of FIG. 10 has a structure in which the heat generating unit (see FIG. 1) of embodiment 1 is used as the heat radiating source. The heating apparatus shown in (b) and (c) of FIG. 10 have structures in which the heat generating units (see FIG. 7) of embodiment 4 are used as the heat radiating source.

The heating apparatus, shown in (a) of FIG. 10, has a structure in which a reflective plate 51 is attached to a position opposite to the plane portion of the heat generating element 2 in a heat generating unit 50. The reflective plate 51 has a parabolic line shape in its cross section orthogonal to the longitudinal direction (extending formation direction), and the heat generating element 2 is located at a position substantially corresponding to the focal point of the parabolic line of the reflective plate 51. In this heating apparatus, the heat radiating source is formed by the heat generating unit 50 and the reflective plate 51 serving as a reflective means.

In addition to the heat generating unit 50 serving as the heat radiating source shown in (a) to (c) of FIG. 10, the heating apparatus of embodiment 5 includes a power supply part for supplying power to the heat generating unit 50, a control part for controlling the power and components that are generally used for a heating apparatus, such as a case forming the apparatus outside appearance, and the like. With respect to the heating apparatus of embodiment 5, the heat generating unit serving as the heat radiating source and the reflective means that are features of the heating apparatus of the invention will be described in detail.

In the heating apparatus of embodiment 5, the heat generating element 2 used for the heat generating unit 50, which is mainly composed of a carbon-based substance, is made into a belt shape by using a film-shaped material having substantially the same thermal conductivity in a plane direction, that is, a so-called two dimensional isotropic thermal conductivity. For this reason, the amount of heat, released from the plane portion of the heat generating element 2, exerts a greater value remarkably in comparison with the amount of heat released from the width face portion (face forming the thickness). In other words, the heat generating element 2 is a heat radiating body having directivity. Therefore, by placing the reflective plate 51 at a position opposite to the plane portion of the heat generating element 2, heat rays, emitted from the back face of the heat generating element 2, are reflected by the reflective plate 51 so that it becomes possible to efficiently heat an object to be heated that is placed in front of the reflective plate 51.

In the heating apparatus shown in (a) of FIG. 10, the reflective plate 51 is placed at a position on the back face side opposite to the plane portion of the heat generating element in the heat generating unit 50, and the cross-sectional shape orthogonal to the longitudinal direction of the reflective plate 51 is formed into a parabolic line shape, with the heat generating center in the heat generating element 2 serving as the heat radiating source being placed at the position corresponding to the focal point of the reflective plate 51. Since the heat generating center of the heat generating element 2 is located at the position of the focal point of the reflective plate 51 in this manner, the heating apparatus shown in (a) of FIG. 10 allows heat emitted from the heat generating element 2 to be reflected by the reflective plate 51 to form parallel heat rays so that highly efficient heat radiation can be obtained.

In the heating apparatus shown in (b) of FIG. 10, the heat generating unit (see FIG. 7) of embodiment 4 is used as a heat radiating source, and a reflective plate 53 is formed at a position on the heat generating unit opposite to the concave face portion of the heat generating element 401. The reflective plate 53 has a parabolic face shape in its cross section orthogonal to the longitudinal direction (extending formation direction), and the heat generating element 401 is disposed at a position corresponding to substantially the focal point on the parabolic face of the reflective plate 53. Moreover, the reflective plate 53 is provided with a convex portion 53A in the center portion opposite to the heat generating unit 52 in its cross-sectional shape orthogonal to the longitudinal direction (extending formation direction). In this heating apparatus, the heat radiating source is configured by the heat generating unit 52 and the reflective plate 53 serving as the reflective means.

In the heat radiating source of the heating apparatus arranged as shown in (b) of FIG. 10, since the convex face of the heat generating element 401 is oriented toward the object to be heated, the heat radiating source is allowed to heat a wide range on the front side. Moreover, one portion of the heat rays radiated to the reflective plate 53 from the concave face of the heat generating element 401 is reflected by the reflective face of the convex portion 53A of the reflective plate 53, and also re-reflected by the end portion of the reflective plate 53 to be radiated toward the front side. For this reason, the heat radiating source of the heating apparatus shown in (b) of FIG. 10 is allowed to heat a wide range on the front side of the reflective plate 53 substantially uniformly. Moreover, since the convex portion 53A is formed on the reflective plate 53 and disposed near the glass tube serving as the heat resistant tube, heat radiation from the glass tube surface is also reflected, with the reflective plate 53 being located closely to the heat generating element 401, so that a superior heat radiating source that provides more heat radiation can be obtained.

As described above, in the heating apparatus shown in (b) of FIG. 10, the reflective plate 53 is disposed at a position opposite to the concave portion of the curved face of the heat generating element 401 in the heat generating unit 52, and the convex portion 53A protruding in the direction of the heat generating element 401 is formed in the center position on the reflective plate 53 opposite to the center portion in the longitudinal direction of the concave portion of the curved face. Heat rays, made incident on the convex portion 53A of the reflective plate 53, are allowed to be reflected in directions other than the direction toward the heat generating element, and again made incident on the reflective plate 53 to be re-reflected toward the front face side. The heating apparatus, arranged in this manner, allows radiated heat from the heat generating element 401 to be reflected by the reflective face of the convex portion 53A toward the front face side more efficiently. Moreover, since at least one portion of the heat generating element 401 is covered with the glass tube 1, the temperature of the heat generating element 401 becomes higher so that it is possible to adjust the temperature distribution of the heating area by using the heating apparatus.

Moreover, in the heating apparatus shown in (b) of FIG. 10, the reflective plate 53 is disposed on the back face side of the heat generating element 401 of the heat generating unit 52, and the reflective plate 53 is designed so that heat rays, reflected by the reflective plate 53, are prevented from irradiating the heat generating element 401; therefore, it is possible to prevent a temperature rise due to secondary heating of the heat generating element 401 by the reflective plate 53, and consequently to achieve a heating apparatus with stable specifications that is free from irregularities. Additionally, in the heat generating element 401 used in the heat generating unit 52, its rate of change in resistance is varied depending on the temperatures of the heat generating element itself. Moreover, in most cases, the ratings of the heat generating unit 52 are set only by taking into consideration the self-heat radiation of the heat generating unit 52. In the case where the heat generating unit 52, set in this manner, is assembled into a heating apparatus, the temperature of the heat generating element 401 rises by heat rays from the reflective plate 53 due to the shape of the reflective plate 53 to cause the ratings of the heating apparatus to change. Since the heating apparatus as shown in (b) of FIG. 10 is designed so as to prevent the heat generating element 401 from being irradiated by the reflective plate 53, it is possible to prevent the ratings of the heat generating unit 52 from being influenced by the reflective plate 401, and consequently to easily design a heating apparatus reliably provided with predetermined desired specifications.

As described above, by installing the reflective plates 51 and 53 serving as the reflective means in the heat generating units 50 and 52, it is possible to configure a heating apparatus having high radiation efficiency.

Additionally, as the shape of the reflective face of the reflective plates 51 and 53 shown in (a) and (b) of FIG. 10, a description has been given by exemplifying a curved face shape with a parabolic face that allows reflected heat rays to be made in parallel with one another; however, the reflective plate of the present invention is not limited to this structure, and various shapes, such as an arc shape, a curved face shape capable of diffused reflection that can widen the radiated heat from the heat generating element, a shape having composite bent faces with multiple stages capable of diffused reflection and the like, may be used in accordance with the objects to be heated.

Moreover, as the shape of the convex portion 53A of the reflective plate 53 shown in (b) of FIG. 10, a description has been given by exemplifying a triangular shape; however, the present invention is not limited to this shape, and various shapes, such as an arc shape, a curved face shape capable of diffused reflection, a shape having composite bent faces with multiple stages capable of diffused reflection and the like, may be used.

The heat generating units 50 and 52 shown in (a) and (b) of FIG. 10 are disposed inside the reflective plates 51 and 53 so as not to protrude from the end portions of the side faces of the reflective plates 51 and 53. By installing the heat generating units inside the reflective plates 51 and 53 in this manner, reflecting processes by the reflective plates 51 and 53 (including diffused radiation from the convex portion 53A and irregular radiation from the concave face) can be carried out with high efficiency.

Moreover, as the material for the reflective plates 51 and 53, aluminum, aluminum alloys, various kinds of stainless steels and the like may be used. Needless to say, it is preferable to apply a surface treatment, such as coating of a reflective material having a high reflective efficiency to the reflective faces of the reflective plates 51 and 53 so as to improve the reflectance of the reflective plates 51 and 53.

Note that, with respect to the cross-sectional shape orthogonal to the longitudinal direction (extending formation direction) in the reflective plates 51 and 53, the present invention is not limited to the parabolic line shape, and any shapes capable of at least applying radiated heat to the back face of the heat generating element so as to heat the object to be heated placed on the front face side of the heat generating element, such as, for example, curved face shapes and polygonal shapes capable of diffused reflection, may be used.

The heating apparatus shown in (c) of FIG. 10 has a structure in which the heat generating unit (see FIG. 7) of embodiment 4 is used as the heat radiating source, with a reflective film 55 being formed on the glass tube 1 of the heat generating unit. The reflective film 55 is formed at a position opposite to the concave face portion of the heat generating element 401 on the outer circumferential face of the glass tube 1 in a manner so as to cover substantially half the area of the glass tube 1. In this heating apparatus, the heat radiating source is configured by the heat generating unit 54 and the reflective film 55 serving as the reflective means. The reflective film 55 is formed by, for example, aluminum vapor deposition, gold transfer, ceramic coating, or the like.

In the heating apparatus shown in (c) of FIG. 10, the reflective film 55 is formed on the back face side of the heat generating element 401 of the heat generating unit 54 so that heat radiation from the heat generating element 401 is reflected substantially in the same direction by the reflective film 55. For this reason, it is possible for the heating apparatus, shown in (c) of FIG. 10, to efficiently heat the object to be heated. In this manner, by forming the reflective film 55 on the back face side of the heat generating unit 54, the radiated heat directed to the back face side can be returned to the heat generating element 401 by the reflective film 55 so that the heat generating element 401 can be heated to a high temperature. As a result, the heat generating element 401 discharges heat radiation having high energy in the same direction from its curved face on the convex side so that the object to be heated can be heated with high efficiency.

As described above, by forming the reflective film 55 serving as the reflective means on the back face of the glass tube 1, it becomes possible to configure a small-size heating apparatus with high radiating efficiency.

### Embodiment 6

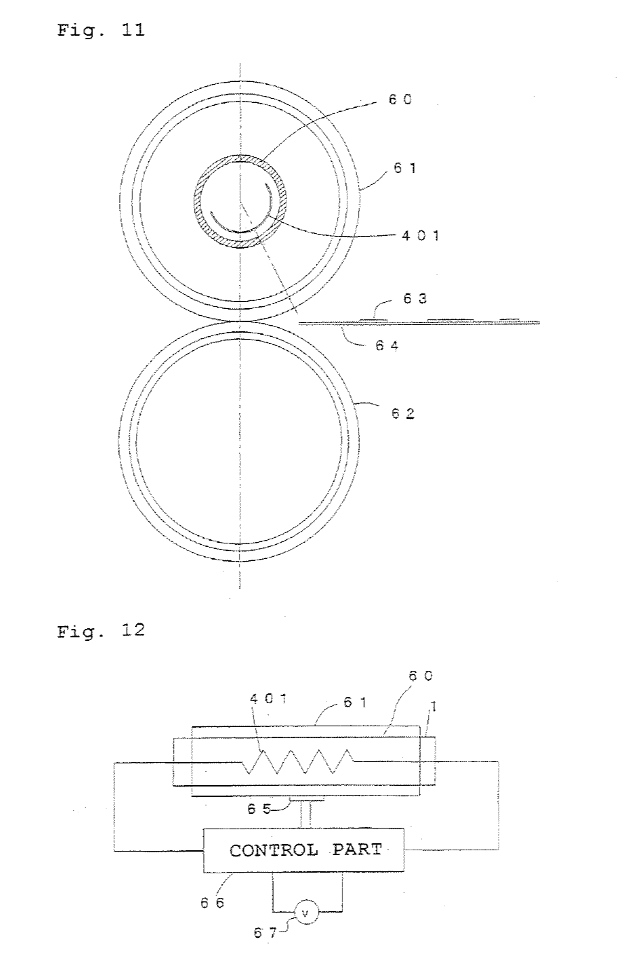

Hereinafter, a heating apparatus in accordance with embodiment 6 of the present invention will be described with reference to FIG. 11.

FIG. 11, which refers to a copying machine as an example of a heating apparatus of embodiment 6, shows a portion near a heat generating unit 60 and the like that serve as its heat radiating source. FIG. 11 is a cross-sectional view taken in a direction orthogonal to the longitudinal direction (extending formation direction) of the heat generating unit 60.

The copying machine serving as the heating apparatus of embodiment 6 uses the heat generating unit (see FIG. 7) of embodiment 4 as the heat radiating source. In the copying machine of embodiment 6, the heat generating unit 60, which is provided with a heat generating element 401 having a cross section orthogonal to the longitudinal direction, formed into a curved face, is surrounded by a tube member 61. In addition to the heat generating unit and the like shown in FIG. 11, the copying machine serving as the heating apparatus of embodiment 6 includes a power supply part for supplying power thereto, a copying mechanism, a control part for controlling the copying mechanism, and components that are generally used for a copying machine, such as a case forming the apparatus outside appearance, and the like.

Since the heating apparatus of embodiment 6 is a copying machine, the tube member 61 surrounding the heat generating unit 60 is a toner fixing roller. Hereinafter, the tube member 61 is described as a toner fixing roller 61.

The toner fixing roller 61 is designed to be in contact with a pressure roller 62 so as to rotate together therewith. A sheet of paper 64 with toner 63 having a predetermined shape supported thereon is inserted between the toner fixing roller 61 and the pressure roller 62, and heated and pressed so as to be fixed thereon. Therefore, in order to efficiently fix the toner 63 on the paper that has been passed through the gap between the toner fixing roller 61 and the pressure roller 62, the curved face on the convex side of the heat generating element 401 is disposed so as to face an area including the opposing faces (toner fixing area) between the toner fixing roller 61 and the pressure roller 62. Here, the direction in which the curved face on the convex side of the heat generating element 401 faces is set so that it is directed to the upstream side of the toner fixing area, that is, the front side area from the toner fixing area of the toner fixing roller 61. By placing the heat generating element 401 in this manner, a heating process is carried out on the toner fixing roller 61, with a portion on the upstream side of the toner fixing area being included therein; thus, the amount of heat accumulation is increased in this portion so that the amount of heat released from the heat generating element 401 can be effectively used for the toner fixing process.

In the heating apparatus of embodiment 6, the tube member serving as the toner fixing roller 61 that is disposed so as to surround the heat generating unit 60 is allowed to radiate heat released from the heat generating unit 60 in a desired direction, and an area facing the center of the curved face on the convex side of the heat generating element 401 is allowed to form the center of heat radiation. The description has been given by exemplifying this tube member (61) as a single member; however, the tube member (61) may also be configured by combining a plurality of members.

In the copying machine serving as the heating apparatus of embodiment 6, by effectively arranging the heat generating unit 60 having directivity in this manner, it becomes possible to provide a heat radiating source with high efficiency.

Next, a temperature controlling method for the heating apparatus of embodiment 6 will be described with reference to FIG. 12. FIG. 12 is a view that schematically shows the structure of a temperature controlling device in the heating apparatus of embodiment 6.

Power supplied from the power supply 67 is controlled in the control part 66 in accordance with an instruction by the user, and applied to the heat generating unit 60. Upon application of power, the heat generating element 401 of the heat generating unit 60 is heated to a high temperature to raise the temperature of the toner fixing roller 61 to a predetermined temperature (toner fixing temperature). A sensor unit 65 is attached to the toner fixing roller 61 so as to detect the temperature of the toner fixing roller 61. The sensor unit 65 feeds back the detected temperature of the toner fixing roller 61 to the control part 66 so that the control part 66 controls the power supplied to the heat generating unit 60 to adjust the temperature of the toner fixing roller 61.

As described above, upon controlling the power to be applied to the heat generating unit, the heating apparatus of embodiment 6 makes it possible to add the detected temperature as another condition to controlling conditions. Moreover, upon controlling the temperature, one of processes, such as an ON/OFF control by using a temperature detection means such as a thermostat, a phase control of the input power supply by using a temperature sensor that detects an accurate temperature, a duty factor control and a zero-cross control, is independently carried out, or some of these are carried out in combination so that it becomes possible to achieve a heating apparatus capable of carrying out the temperature control with high precision.

Therefore, in accordance with the heating apparatus of embodiment 6 arranged as described above, the directivity control is carried out by properly disposing the heat generating element and the applied power control is carried out by the detected temperature so that a heating operation with superior radiation characteristics and a temperature control with high precision are available.

In the heating apparatus of embodiment 6, a description has been given by exemplifying the heat generating unit (see FIG. 7) of embodiment 4 as the heat radiating source; however, any of the structures of the heat generating units described in the respective embodiments may be used as the heat radiating source, and the same effects can be obtained.

Moreover, a description has been given by exemplifying a copying machine as the heating apparatus of embodiment 6; however, the heat generating unit of the present invention can be used for a heat radiating source for fixing toner also in an electronic apparatus, such as a facsimile and a printer, and the same effects can be obtained. In the case where the mechanism is used for fixing toner in an electronic apparatus, such as a copying machine, a facsimile and a printer, the heat generating unit to be used as a heat radiating source is used in a manner so as to be surrounded by a tube member referred to as a roller.

Furthermore, in addition to electronic apparatuses, such as a copying machine, a facsimile and a printer, the heating apparatuses of the present invention also include electric heating apparatuses, such as a heating stove, cooking apparatuses, such as a cooking and heating device, drying machines for foods and the like, and other apparatuses that require heating processes to a high temperature in a short period of time.

In the heating apparatus of the present invention, the roller serving as a tube member that surrounds the heat generating unit has a structure in which the inner side is formed by a metal material and the outer side is coated with a silicon resin, with driving gears and the like for use in driving being attached to the two sides of the roller. In order to enhance the absorbing property for heat and the like, a ceramic material, a far infrared paint or the like may be applied to the inner side of the roller. Moreover, from the viewpoints of heat-releasing and heat-absorbing properties and strength, the tube member may be configured by a plurality of metal members, such as aluminum, iron and the like, so as to obtain higher heating efficiency.

In the case where the heat generating unit of the present invention is used as a heat source for a cooking apparatus, the heat generating unit is disposed in a manner so as to be surrounded by a tube member. The tube member is a tube-shaped heat resistant pipe made of a single member or a plurality of members. In the case where the heat generating unit having a heat generating element surrounded by a quartz glass tube, as it is, is used as a heat source for a cooking apparatus, the quartz glass tube tends to cause erroneous permeation due to alkali metal ions and the like, contained in seasonings and the like, such as salt and soy source, that are used in cooking processes, and subsequent damages, with the result that the heat generating unit serving as the heat source has a shortened service life. For this reason, by designing the heat generating unit so as to be surrounded by a tube member that is a heat resistant pipe, it becomes possible to prolong the service life of the heat generating unit.

Note that, by using crystallized glass having superior light transmittance, ceramics having a high amount of radiation of far infrared rays and the like as the tube member, the applications of the apparatus can be widened.

With respect to the positional relationship between the heat generating unit and an object to be heated, needless to say, by directing the heating center of the heat generating element to the heating object side, it becomes possible to heat the heating object with high efficiency.

As described above, in the heat generating unit of the present invention, a heat generating element, which is mainly composed of a carbon-based substance, is made into a film sheet shape having substantially the same thermal conductivity in a plane direction, that is, a so-called two dimensional isotropic thermal conductivity, and has pliability, flexibility and elasticity. Moreover, the heat generating element has a thermal conductivity of 200 W/m·K or more and a thickness of 300 μm or less. The heat generating element having such an arrangement makes it possible to easily carry out machining processes, such as cutting out, hole-forming, bending, and cutting and raising processes, thereon, so that the heat generating element is easily formed into a shape in which a cross-sectional shape orthogonal to the longitudinal direction thereof has a curved face. Furthermore, the heat generating element, formed in the heat generating unit of the present invention, can be modified into various shapes, such as a pipe shape, a plate shape, a curved shape with a pipe shape being bent in the longitudinal direction, a shape with a pipe shape being formed into a round shape, in accordance with the shape of a container (heat resistant pipe), and can also be modified with high precision in accordance with the service objectives, and assembled into the apparatus.

Moreover, in the heat generating unit of the present invention, the heat generating element is formed into a mode in accordance with the service objectives so that heat radiation can be exerted with high efficiency from a plane portion or a curved face portion of the heat generating element.

Furthermore, in the heat generating unit of the present invention, the heat generating element has two dimensional isotropic thermal conduction and is formed into a film-sheet shape having properties such as pliability, flexibility and elasticity; therefore, not only a power-applied heat-generating portion in which a current is allowed to flow to generate heat, but also portions other than the power-applied portion are allowed to generate heat by heat conduction from the power-applied heat-generating portion. Therefore, the heat generating element can be formed into a structure having a complicated pattern (shape) so that it becomes possible to eliminate irregularities in the heat generating temperature due to a slight difference in thicknesses caused by a machining process and consequently to increase the degree of margin in machining precision.

Moreover, in the heat generating unit of the present invention, the tube-shaped heat resistant tube (glass tube 1 shown in FIG. 1) is filled with a gas with the two end portions being sealed; thus, since it is possible to use the heat generating unit, without causing oxidation in the heat generating element inside the heat resistant tube, under a firing temperature of the heat generating element, the degree of freedom in designing the heat generating element can be further widened. Moreover, since the heat generating element used in the present invention has properties such as pliability, flexibility and elasticity, and also has a high shape-retaining property under a high temperature, it is possible to form the heat generating element into a desired shape, and consequently to improve the degree of freedom in selecting heat resistant tube materials as well as in holding the heat generating element.

As described in embodiment 5, in the heating apparatus shown in (a) of FIG. 10, the reflective plate is placed at a position on the back face side opposite to the plane portion of the heat generating element in the heat generating unit of the present invention, the cross-sectional shape orthogonal to the longitudinal direction of the reflective plate is formed into a parabolic line shape, and the heat generating center in the heat generating element serving as the heat radiating source is placed at a position corresponding to the focal point of the reflective plate. Since the heat generating center of the heat generating element is located at the focal point of the reflective plate in this manner, the heating apparatus of the present invention makes it possible to provide heat radiation with high efficiency, with radiated heat from the heat generating element being reflected by the reflective plate.

Moreover, as described in embodiment 5, in the heating apparatus shown in (b) of FIG. 10, a reflective plate is disposed at a position on the heat generating unit opposite to the concave face portion of the heat generating element, and a convex portion protruding toward the heat generating element is placed in the center position on the reflective plate opposite to the center portion in the longitudinal direction of the concave portion of the curved face. Heat rays which have been made incident on the convex portion of the reflective plate are reflected in directions other than the direction toward the heat generating element, and are again made incident on the reflective plate to be re-reflected toward the front face side. In the heating apparatus arranged in this manner, the radiated heat from the heat generating element is directed toward the front face side by the reflective face on the convex portion with high efficiency. Moreover, since at least one portion of the heat generating element is covered with a heat resistant tube, the temperature of the heat generating element becomes higher so that the temperature distribution in the heating area can be adjusted by the heating apparatus of the present invention.

Moreover, in the heating apparatus shown in (b) of FIG. 10, a reflective plate is disposed on the back face side of the heat generating element of the heat generating unit so that the heat generating element is not irradiated with heat rays that are reflected by the reflective plate; therefore, it is possible to prevent a temperature rise due to secondary heating of the heat generating element by the reflective plate, and consequently to achieve a heating apparatus with stable specifications that is free from deviations. In the heat generating element used in the heat generating unit, its rate of change in resistance is varied depending on the temperatures of the heat generating element itself. Moreover, in most cases, the ratings of the heat generating unit are set only by taking into consideration the self-heat radiation of the heat generating unit. In the case where the heat generating unit, set in this manner, is assembled into a heating apparatus, the temperature of the heat generating element rises by heat rays from the reflective plate due to the shape of the reflective plate to cause the ratings of the heating apparatus to change. Since the heating apparatus of the present invention is designed so as to prevent the heat generating element from being irradiated by the reflective plate, it is possible to prevent the ratings of the heat generating unit from being influenced by the reflective plate, and consequently to easily design a heating apparatus reliably provided with predetermined desired specifications.

As described in embodiment 5, in the heating apparatus shown in (c) of FIG. 10, a reflective film is formed on the back face side of the heat generating element of the heat generating unit so that the heat radiation from the heat generating element is reflected substantially in the same direction by the reflective film; therefore, it becomes possible to efficiently heat the object to be heated. In this manner, by forming the reflective film on the back face side of the heat generating unit, the radiated heat directed to the back face side can be returned to the heat generating element by the reflective film so that the heat generating element can be heated to a high temperature. As a result, the heat generating element discharges radiation heat having high energy in the same direction from its curved face on the convex side so that the object to be heated can be heated with high efficiency.

Moreover, in the heating apparatus of the present invention, as described in embodiment 6, the heat generating element of the present invention may be installed, with a tube member covering the heat generating unit being disposed. With this structure, foreign matters, generated by the object to be heated or the like, such as meat juice, seasonings and the like, are shield by the tube member to be prevented from directly coming into contact with the heat generating unit. With this arrangement, it is possible to prevent damages and disconnections due to degradation of the surface of the heat generating unit, and consequently to provide a heating apparatus with a longer service life.

Moreover, in the heating apparatus of the present invention, in the case where the heat generating unit is used, for example, as a heat source of an electronic apparatus, such as a copying machine or the like, by using the tube member covering the heat generating unit as a toner fixing roller, it becomes possible to provide a structure in which a portion of the toner fixing roller to come in contact with paper can be heated with high efficiency.

Furthermore, in the heating apparatus of the present invention, by using a structure in which at least one portion of the heat generating element is covered with a heat resistant tube, it becomes possible to raise the temperature of the heat generating element to a higher level, and consequently to provide a heating apparatus that can alter the heating distribution.

The heat generating unit and the heating apparatus of the present invention uses a heat generating element that is mainly composed of a carbon-based substance, and made by a film shaped material that has a two dimensional isotropic thermal conductivity, as well as pliability, flexibility and elasticity, and also has a thermal conductivity of 200 W/m·K or more, with a thickness of 300 μm or less, and this heat generating element has a high radiating rate of 80% or more.

Although the invention has been shown and described in detail with respect to preferred modes, the contents of the disclosure of these preferred modes can be modified in detailed portions of the structures, and the combinations and the change in the order of the respective components can be devised without departing from the scope and spirit of the invention.

### INDUSTRIAL APPLICABILITY

Since the heat generating unit in accordance with the present invention has a small size with high efficiency, it can be applied widely as heat sources, and a heating apparatus using the heat generating unit makes it possible to carry out a heating with high efficiency, and is effectively applied.

1. A heat generating unit comprising:
a heat generating element that is formed into a film shape by using a material containing a carbon-based substance which is formed by heating a polymer film of a polymer film with filler added thereto, and has a two dimensional isotropic thermal conductive property in a plane direction;
a power supply part that supplies power to two opposing ends of the heat generating element; and
a container that encloses the heat generating element and the power supply part.

2. The heat generating unit according to claim 1, wherein the heat generating element comprises an applied-power heat generating portion in which a current flows to generate heat and radiate heat, and a conducted heat-generating portion in which heat is generated to radiate the heat due to heat conduction from the applied-power heat generating portion.

3. The heat generating unit according to claim 1, wherein the heat generating element has a structure in which wide width portions and narrow width portions are sequentially and alternately disposed in a longitudinal direction.

4. The heat generating unit according to claim 1, wherein a hole is formed in each of the wide width portions of the heat generating element to prepare a power-applied heat-generating passage so that the heat generating element has a wide width portion which has a different resistance value per unit length in the power-applied heat-generating passage.

5. The heat generating unit according to claim 1, wherein the power supply part has a holding block that holds the heat generating element, with a heat resistant member being formed on at least one side of the holding portion in the heat generating element.

6. The heat generating unit according to claim 1, wherein the power supply part has a holding block that holds the heat generating element, with a convex portion being formed on one portion of the holding portion of the holding block.

7. The heat generating unit according to claim 1, wherein the heat generating element is formed by using a material having pliability, flexibility and elasticity.

8. The heat generating unit according to claim 1, wherein at least one portion of areas in the longitudinal direction in the heat generating element is configured so as to have a different resistance value per unit length in the longitudinal direction.

9. The heat generating unit according to claim 1, wherein the container is configured by using either a glass tube or a ceramic tube having a heat resistant property.

10. The heat generating unit according to claim 1, wherein at least one portion of a cross-sectional shape orthogonal to the longitudinal direction of the heat generating element is formed into a curved face.

11. The heat generating unit according to claim 1, wherein at least one portion of the container in the longitudinal direction is formed into a curved face.

12. The heat generating unit according to claim 1, wherein at least one of the ends of the tube-shaped container is sealed at the power supply part, with the container being filled with an inert gas.

13. The heat generating unit according to claim 1, wherein the heat generating element has a film sheet shape in which a plurality of film sheet elements are laminated in a thickness direction with one another, with a void being formed therebetween, by using a material having a conductivity of 200 W/m·k or more.

14. The heat generating unit according to claim 1, wherein the heat generating element is formed into a film sheet shape with a thickness of 300 μm or less.

15. The heat generating unit according to claim 1, wherein the heat generating element is formed by using a graphite film obtained by subjecting a polymer film, or a polymer film to which a filler is added, to a heating treatment at a temperature of 2400° C. or more.

16. The heat generating unit according to claim 1, wherein at least one portion of an outer shape, a hole shape and a cut-in shape of the heat generating element is formed by a laser machining process.

17. A heating apparatus comprising:
a heat generating unit that includes: a heat generating element that is formed into a film shape by using a material containing a carbon-based substance which is formed by heating a polymer film of a polymer film with filler added thereto, and has a two dimensional isotropic thermal conductive property in a plane direction; a power supply part that supplies power to two opposing ends of the heat generating element; and a container that encloses the heat generating element and the power supply part,
wherein reflective means is disposed at a position opposite to the heat generating element.

18. The heating apparatus according to claim 17, wherein the heat generating element comprises an applied-power heat generating portion in which a current flows to generate heat and radiate heat, and a conducted heat-generating portion in which heat is generated to radiate the heat due to heat conduction from the applied-power heat generating portion.

19. The heating apparatus according to claim 17, wherein the heat generating element has a structure in which wide width portions and narrow width portions are sequentially and alternately disposed in a longitudinal direction.

20. The heating apparatus according to claim 19, wherein a hole is formed in each of the wide width portions of the heat generating element to prepare a power-applied heat-generating passage so that the heat generating element has a wide width portion which has a different resistance value per unit length in the power-applied heat-generating passage.

21. The heating apparatus according to claim 17, wherein the reflective means is a reflective plate having a cross-sectional face in a longitudinal direction, formed into a curved shape.

22. The heating apparatus according to claim 17, wherein the reflective means is a reflective plate having a cross-sectional face in a longitudinal direction, with a convex portion protruding toward the heat generating element being formed at one portion of the reflective plate.

23. The heating apparatus according to claim 17, wherein the reflective means is a reflective film formed on the heat generating unit.

24. A heating apparatus comprising:
a heat generating unit that includes: a heat generating element that is formed into a film shape by using a material containing a carbon-based substance which is formed by heating a polymer film of a polymer film with filler added thereto, and has a two dimensional isotropic thermal conductive property in a plane direction; a power supply part that supplies power to two opposing ends of the heat generating element; and a container that encloses the heat generating element and the power supply part,
wherein a tube member is disposed so as to surround a periphery of the heat generating unit.

25. The heating apparatus according to claim 24, wherein the heat generating element comprises an applied-power heat generating portion in which a current flows to generate heat and radiate heat, and a conducted heat-generating portion in which heat is generated to radiate the heat due to heat conduction from the applied-power heat generating portion.

26. The heating apparatus according to claim 24, wherein the heat generating element has a structure in which wide width portions and narrow width portions are sequentially and alternately disposed in a longitudinal direction.

27. The heating apparatus according to claim 26, wherein a hole is formed in each of the wide width portions of the heat generating element to prepare a power-applied heat-generating passage so that the heat generating element has a wide width portion which has a different resistance value per unit length in the power-applied heat-generating passage.

28. The heating apparatus according to claim 17, further comprising:
a control circuit that carries out an electrical controlling process on the heat generating unit,
wherein the control circuit is provided with one of circuits or at least two or more of combined circuits, selected from an ON/OFF control circuit, a duty factor control circuit, a phase control circuit and a zero-cross control circuit.
